(19) United States
(12) Patent Application Publication
(10) Pub. No.: US 2021/0326814 A1
(43) Pub. Date: Oct. 21, 2021

(54) SYSTEMS, METHODS, AND USER INTERFACES FOR PLANNING, EXECUTION, AND VERIFICATION OF CONSTRUCTION TASKS

(71) Applicant: iBUILD Global, Inc., Washington, DC (US)

(72) Inventors: Lew SCHULMAN, Arlington, VA (US); Jonathan GODBOUT, Worcester, MA (US); Ronald OMYONGA, Nairobi (KE)

(73) Assignee: iBUILD Global, Inc., Washington, DC (US)

(21) Appl. No.: 17/312,576

(22) PCT Filed: Jul. 8, 2019
(86) PCT No.: PCT/US2019/040827

§ 371 Date: Jun. 10, 2021

Related U.S. Application Data
(60) Provisional application No. 62/780,047, filed on Dec. 14, 2018.

(51) Int. Cl. G06Q 20/02; G06Q 10/10; G06Q 50/08; G06Q 20/32; G06Q 40/02; G06Q 20/40; G06Q 20/36; H04W 4/80; G01S 19/14

(52) U.S. Cl. CPC G06Q 20/02; G06Q 10/103; G06Q 50/08; G06Q 20/3223; G06Q 40/02; G01S 19/14; G06Q 20/3224; G06Q 20/3674; G06Q 20/321; G06Q 20/3278; H04W 4/80; G06Q 20/4015

(57) ABSTRACT

A system for verifying completion of a construction task is provided, wherein the system receives verification data from an electronic device of a building party indicating that a construction task has been completed, and responsively transmits, to a verifying party, a request to verify the completion of the task based on the verification data. A system for facilitating payment using a digital wallet is provided, wherein the system executes a deposit into the wallet based on a first identification code received and executes a withdrawal request based on a second identification code received. A system for verifying presence of a worker at a work site is provided, wherein a first electronic device detects the presence of a worker, such as by detecting the presence of the worker's electronic device, and automatically prompts a user of the first electronic device to confirm the worker's presence.

### CROSS REFERENCE TO RELATED APPLICATIONS

This application claims the benefit of U.S. Provisional Application No. 62/780,047, filed Dec. 14, 2018, the entire contents of which are hereby incorporated herein by reference.

### FIELD

The present disclosure relates to home construction, and more specifically to an electronic platform for monitoring and verifying completion of construction tasks, for facilitating exchange of funds used in home construction tasks, and for monitoring and verifying worker presence for construction, particularly in the informal construction sector in developing countries.

### BACKGROUND

The world's population will increase from about seven billion today to over eight billion in 2025. If current trends in urbanization and income growth persist, it is estimated that the global affordable housing gap will grow from 330 million households to 440 million by 2025, leaving at least 1.6 billion people living in substandard housing.

Among lower-income people (over four billion globally), conventional home development is often too expensive, and alternative housing schemes such as incremental housing are the only available options. For example, in Africa, over 85% of households cannot afford the cheapest formal development home. Additionally, 60-90% of construction workforces in developing countries are informal and unorganized. For example, in India, 97% of women and 89% of the men in construction are part of the informal workforce.

Accordingly, home construction and improvements to existing homes in developing countries are most often undertaken incrementally, and usually by way of direct transactions between homeowners and informal contractors, or direct transactions between homeowners and workers/builders. In most instances, construction projects or home-improvement projects (herein, each referred to as construction projects) are paid in cash, often on a half-now-half-later basis. Paying informal workers in cash on a half-now-half-later basis is an attempt to mitigate problems with accountability of home buyers (e.g., to ensure that buyers do in fact have funds for the projects they are commissioning) and problems with accountability of workers (e.g., to ensure that workers do in fact complete all work for which they have already been paid).

### SUMMARY

As explained above, home construction in developing countries is largely undertaken in incremental fashion, and is usually based on private cash dealings between a homeowner and an informal worker or group or workers. However, several problems with this current system exist. For example, families and homeowners find it difficult to navigate the construction process and have no means to verify quality of ongoing construction work. Furthermore, contractors find it difficult to identify, manage, and pay skilled workers. Additionally, informal construction workers lack a clear pathway to find work, grow in their trade, and ensure secure payment for work that they have done. While cash dealing, for example on a half-now-half-later basis, may mitigate some risk, it still does not prevent families and homeowners from losing down-payments on work that is never done if a disreputable contractor does not complete the promised work; nor, on the other hand, does it prevent a contractor from failure of a disreputable buyer to pay. Accordingly, there is a need for systems and methods to address these problems in the incremental and small-scale home construction industry in developing countries, particularly by providing homeowners, contractors, and workers with access to a secure and transparent system for the hiring of workers, the verification of construction work, and the secure exchange of funds following verification of construction work.

Disclosed herein are systems, methods, devices, and user interfaces for facilitating completion of incremental and small-scale home construction.

In some embodiments, systems are provided for providing an electronic user interface, graphical user interface, and/or mobile application interface allowing workers, contractors, homeowners/families/purchasers, and other parties to small-scale and incremental construction projects to connect to one another in order to execute contracting for, monitoring of, and payment for construction projects. Throughout this disclosure, a mobile application interface may be referred to by way of example, but it should be understood that the systems and techniques taught herein with respect to mobile application interfaces may be equally applicable, in some embodiments, to any electronic user interface and/or graphical user interface, whether or not provided by way of a mobile application interface. In some embodiments, a system may comprise a mobile application that includes one or more application interfaces usable by various parties to small-scale and/or incremental home construction, such as workers, contractors, and homeowners/families/purchasers. The mobile application may be accessible by end users using mobile electronic devices, and may allow for various parties to fund and control a private digital wallet. Transactions between different private parties using the application (e.g., a homeowner sending payment for completion of a construction task to a worker) may be carried out using the digital wallets of the respective parties, and the transfer of funds from one wallet to another may be conditioned on the completion and verification of user-definable construction tasks. In particular, exchanges of funds using the digital wallets through the application platform may be structured such that any exchange of funds is associated in the platform with a predefined construction event, such as the completion of a milestone or task, the working of a certain number of hours, and/or the completion of a construction project. By associating some or all transfers of funds between wallets (and/or other accounts) in the system with specific construction events, transparency and accountability may be increased, and the efficiency of construction projects (including completing payment therefor) may be improved.

In some embodiments, the interface may facilitate the verification of completion of construction tasks by allowing users to send and review geotagged and/or timestamped photographs of a construction site to one another, such that the homeowner/purchaser may review the photograph before marking the task as completed and allowing distribution of funds (which may in some embodiments be held in escrow while construction work is undertaken).

In some embodiments, digital wallets in the system may be linked to third-party systems to facilitate the transfer of funds into and out of the system itself (rather than the transfer of funds between different private wallets in the system). For example, users of the system may make deposits into their own private digital wallets by transferring funds from outside accounts, and may make withdrawals from their own private digital wallets by transferring funds to their outside accounts. In some embodiments, an outside banking account may be electronically linked to the system for deposit and withdrawal of funds. However, because many individuals in developing countries do not have access to formal banking resources, the system may be alternately or additionally configured to be electronically linked to alternate outside sources for transferring funds into or out of the system, including but not limited to “mobile money” accounts associated with, for example, wireless services providers. In some embodiments, identification codes such as paybill numbers used by mobile money transfer systems may be automatically executed by the system (e.g., called by an API behind the scenes) upon receipt of a user instruction to transfer money into or out of the system, and the transferred funds may then be accounted for by maintaining a database reflecting the amount of funds present in each individual user's wallet at each point in time. Once funds are transferred into a digital wallet of the construction platform, funds may, in some embodiments, be transferred internally (e.g., to/from other digital wallets, into escrow accounts inside the system, etc.) if those transfers are linked in the system with the completion of a construction task.

In some embodiments, systems are provided for tracking and monitoring presence or workers on small-scale and incremental construction projects. In some embodiments, said systems may comprise the same systems discussed above, including a mobile application platform usable by homeowners/families/purchasers, contractors, and workers. In some embodiments, an interface for a contractor or work site manager may enable monitoring of worker presence at a work site. For example, in some embodiments, a contractor or work site manager may be able to use the interface to input information regarding clock-in and/or clock-out times for specific workers, such that workers' hours may be tracked. In some embodiments, near-field communication (NFC) devices may be utilized to verify worker presence and to record clock-in and/or clock-out of workers. For example, workers may tap their personal smart phones and/or dedicated NFC devices to a device of the contractor or work site manager, and an exchange of information over NFC may facilitate recording a clock-in and/or clock-out time for the worker. In some embodiments, a worker may use an NFC communication device embedded in a wearable device. In some embodiments, a worker may use an NFC communication device that is part of a payment system, such as a prepaid NFC payment device, to clock in and/or clock out of a work site. Throughout this disclosure, NFC communication devices may be referred to by way of example, but it should be understood that the systems and techniques taught herein with respect to NFC communication devices may be equally applicable, in some embodiments, to any electronic touchless technology, such as optical scanners (e.g., barcode devices, QR code devices), any suitable wireless network communication protocol, or the like.

In some embodiments, the systems, interfaces, methods, techniques, and applications disclosed herein may be provided as part of a software as a service (SaaS) platform, such that one or more of the functionalities disclosed herein may be enabled via software provided to a plurality of remote users accessing the software by network communication. Furthermore, in some embodiments, the systems, interfaces, methods, techniques, and applications disclosed herein may be provided via a “push and pull” deployment strategy. For example, as explained herein in further detail, “pull” strategies may be implemented to engage one or more parties such as small-scale construction workers and contractors with the systems described herein, while “push” strategies may be implemented to engage one or more parties such as such as banks, government organizations, and NGO's that may work with providers of the system described herein to address transparency issues at scale for large lenders and developers building large scale construction projects.

In some embodiments, a first system for verifying completion of a construction task is provided, the first system comprising one or more processors configured to be in network communication with a first mobile electronic device and a second mobile electronic device, wherein: the first mobile electronic device is associated with a building party and comprises an image capture device; the second mobile electronic device is associated with a verifying party; and the one or more processors are configured to: generate and store data representing a construction task to be completed by a user of the mobile electronic device, wherein the data comprises an indication that completion of the construction task must be verified by the verifying party; receive, from the first mobile electronic device, a message indicating that the construction task has been completed, wherein the message comprises verification data; transmit, to the second electronic device, a request to verify completion of the construction task, wherein the request comprises the verification data received from the first mobile electronic device; receive, from the second mobile electronic device, a response message indicating whether or not completion of the construction task is verified; if the response message indicates that completion of the construction task is verified, generate and store data indicating that the task is completed; and if the response message indicates that completion of the construction task is not verified, generate and store data indicating that the task is not completed.

In some embodiments of the first system, the one or more processors are configured to: if the response message indicates that completion of the construction task is verified, transmit a confirmation message to the first mobile electronic device confirming that the construction task has been verified; and if the response message indicates that completion of the construction task is not verified, transmit a rejection message to the first mobile electronic device indicating that the construction task has not been verified.

In some embodiments of the first system, the one or more processors are configured to: if the response message indicates that completion of the construction task is verified, generate and store an indication in a database permitting pre-allocated funds associated with the construction task to be released from escrow.

In some embodiments of the first system, the verification data comprises an image captured using the image capture device of the first mobile electronic device.

In some embodiments of the first system, the verification data comprises metadata associated with the image.

In some embodiments of the first system, the metadata comprises temporal data.

In some embodiments of the first system, the metadata comprises location data.

In some embodiments, a first method for verifying completion of a construction task is provided, the first method performed at a system comprising one or more processors configured to be in network communication with a first mobile electronic device and a second mobile electronic device, wherein: the first mobile electronic device is associated with a building party and comprises an image capture device; and the second mobile electronic device is associated with a verifying party; and the first method comprising: generating and storing, by the one or more processors, data representing a construction task to be completed by a user of the mobile electronic device, wherein the data comprises an indication that completion of the construction task must be verified by the verifying party; receiving, by the one or more processors, from the first mobile electronic device, a message indicating that the construction task has been completed, wherein the message comprises verification data; transmitting, from the one or more processors, to the second electronic device, a request to verify completion of the construction task, wherein the request comprises the verification data received from the first mobile electronic device; receiving, by the one or more processors, from the second mobile electronic device, a response message indicating whether or not completion of the construction task is verified; if the response message indicates that completion of the construction task is verified, generating and storing, by the one or more processors, data indicating that the task is completed; and if the response message indicates that completion of the construction task is not verified, generating and storing, by the one or more processors, data indicating that the task is not completed.

In some embodiments, a first non-transitory computer-readable storage medium for verifying completion of a construction task is provided, the first non-transitory computer-readable storage medium storing instructions configured to be executed by a system comprising one or more processors configured to be in network communication with a first mobile electronic device and a second mobile electronic device, wherein: the first mobile electronic device is associated with a building party and comprises an image capture device; the second mobile electronic device is associated with a verifying party; and execution of the instructions by the one or more processors causes the one or more processors to: generate and store data representing a construction task to be completed by a user of the mobile electronic device, wherein the data comprises an indication that completion of the construction task must be verified by the verifying party; receive, from the first mobile electronic device, a message indicating that the construction task has been completed, wherein the message comprises verification data; transmit, to the second electronic device, a request to verify completion of the construction task, wherein the request comprises the verification data received from the first mobile electronic device; receive, from the second mobile electronic device, a response message indicating whether or not completion of the construction task is verified; if the response message indicates that completion of the construction task is verified, generate and store data indicating that the task is completed; and if the response message indicates that completion of the construction task is not verified, generate and store data indicating that the task is not completed.

In some embodiments, a second system for facilitating payment using a digital wallet is provided, the second system comprising one or more processors configured to be in network communication with a mobile electronic device and with a remote server associated with a plurality of identification codes for facilitating payments, wherein the one or more processors are configured to: receive, from the mobile electronic device, a deposit request indicating a request to deposit a first amount of funds into a digital wallet associated with a user account; in response to receiving the deposit request, transmit, from the one or more processors to the remote server, a first funds transfer message comprising an indication of the first amount of funds and a first identification code of the plurality of identification codes, the first identification code uniquely associated with transferring funds to a digital wallet database of the system; receive, from the mobile electronic device, a withdrawal request indicating a request to withdraw a second amount of funds from the digital wallet associated with the user account; in response to receiving the withdrawal request, transmit, from the one or more processors to the remote server, a second funds transfer message comprising an indication of the second amount of funds and a second identification code of the plurality of identification codes, the second identification code uniquely associated with transferring funds from a digital wallet database of the system.

In some embodiments of the second system, the one or more processors are configured to generate and store the digital wallet database, the database representing a plurality of account-specific digital wallets, wherein the plurality of account-specific digital wallets comprises the digital wallet associated with the user account, and wherein the database stores a plurality of entries representing respective amounts of funds stored in each of the plurality of digital wallets.

In some embodiments of the second system, the one or more processors are configured to process deposit requests for each of the plurality of digital wallets using the same first identification code.

In some embodiments of the second system, the one or more processors are configured to process withdrawal requests for each of the plurality of digital wallets using the same second identification code.

In some embodiments of the second system, the one or more processors are configured to, after receiving a first funds transfer associated with the deposit request, update the database to reflect deposit of the first amount of funds to the digital wallet associated with the user account.

In some embodiments of the second system, the one or more processors are configured to, after receiving a second funds transfer associated with the withdrawal request, update the database to reflect withdrawal of the second amount of funds from the digital wallet associated with the user account.

In some embodiments of the second system, the mobile electronic device is configured to: display a user interface comprising a first field for entry of a deposit amount; receive, via an input device, a first input from a user entering the first amount as the deposit amount in the first field; in response to receiving the first input, generate and transmit the deposit request.

In some embodiments of the second system, generating and transmitting the deposit request is executed without receiving the first identification code from the user.

In some embodiments of the second system, the user interface comprises a second field for entry of a withdrawal amount, and wherein the mobile electronic device is configured to: receive, via the input device, a second input from the user entering the second amount as the withdrawal amount in the second field; in response to receiving the second input, generate and transmit the withdrawal request.

In some embodiments of the second system, generating and transmitting the withdrawal request is executed without receiving the second identification code from the user.

In some embodiments, a second method for facilitating payment using a digital wallet is provided, the second method performed at a system comprising one or more processors configured to be in network communication with a mobile electronic device and with a remote server associated with a plurality of identification codes for facilitating payments, the second method comprising: receiving, by the one or more processors, from the mobile electronic device, a deposit request indicating a request to deposit a first amount of funds into a digital wallet associated with a user account; in response to receiving the deposit request, transmitting, from the one or more processors, to the remote server, a first funds transfer message comprising an indication of the first amount of funds and a first identification code of the plurality of identification codes, the first identification code uniquely associated with transferring funds to a digital wallet database of the system; receiving, by the one or more processors, from the mobile electronic device, a withdrawal request indicating a request to withdraw a second amount of funds from the digital wallet associated with the user account; in response to receiving the withdrawal request, transmitting, from the one or more processors, to the remote server, a second funds transfer message comprising an indication of the second amount of funds and a second identification code of the plurality of identification codes, the second identification code uniquely associated with transferring funds from a digital wallet database of the system.

In some embodiments, a second non-transitory computer-readable storage medium for facilitating payment using a digital wallet is provided, the second non-transitory computer-readable storage medium storing instructions configured to be executed by a system comprising one or more processors configured to be in network communication with a mobile electronic device and with a remote server associated with a plurality of identification codes for facilitating payments, wherein execution of the instructions by the one or more processors causes the one or more processors to: receive, from the mobile electronic device, a deposit request indicating a request to deposit a first amount of funds into a digital wallet associated with a user account; in response to receiving the deposit request, transmit, from the one or more processors to the remote server, a first funds transfer message comprising an indication of the first amount of funds and a first identification code of the plurality of identification codes, the first identification code uniquely associated with transferring funds to a digital wallet database of the system; receive, from the mobile electronic device, a withdrawal request indicating a request to withdraw a second amount of funds from the digital wallet associated with the user account; in response to receiving the withdrawal request, transmit, from the one or more processors to the remote server, a second funds transfer message comprising an indication of the second amount of funds and a second identification code of the plurality of identification codes, the second identification code uniquely associated with transferring funds from a digital wallet database of the system.

In some embodiments, a third system for verifying presence of a worker at a work site is provided, the third system comprising: a first mobile electronic device associated with the work site, wherein the first mobile electronic device comprises a display, an input device, and a first near-field communication device; and a second mobile electronic device associated with the worker, wherein the second mobile electronic device is comprises a second near-field communication device; wherein the first and second mobile electronic devices are configured to exchange information via near-field communication with one another, wherein the information comprises data uniquely identifying the second mobile electronic device associated with the worker; and wherein the first mobile electronic device is configured to: in response to detecting the exchange of information, display an interface prompting a user of the first mobile electronic device to confirm the presence of the worker at the work site; detect, via the input device, a first input confirming the presence of the worker at the work site; and in response to detecting the first input, generating an entry for storage in a database indicating that the worker is present at the work site at a time of the exchange of information.

In some embodiments of the third system, generating and storing the entry in the database is performed in accordance with determining that geolocation data associated with the time of the exchange matches geolocation data for the work site.

In some embodiments of the third system, the geolocation data is detected by a GPS sensor of the first mobile electronic device at a time associated with the time of the exchange.

In some embodiments of the third system, the geolocation data is detected by a GPS sensor of the second mobile electronic device at a time associated with the time of the exchange.

In some embodiments of the third system, the system comprises a remote server configured to receive, via network communication from the first mobile electronic device, a transmission comprising an instruction to store the entry in the database.

In some embodiments of the third system, the first mobile electronic device is configured to function in a mode selected from: NFC reader/writer mode and NFC peer-to-peer mode.

In some embodiments of the third system, the first mobile electronic device is one of a smart phone and a tablet.

In some embodiments of the third system, the second mobile electronic device is configured to function in a mode selected from: NFC reader/writer mode, NFC peer-to-peer mode, and NFC card emulation mode.

In some embodiments of the third system, the second mobile electronic device is one of a smart phone, a tablet, and an NFC tag.

In some embodiments of the third system, the second mobile electronic device is an NFC tag embedded in a wearable device.

In some embodiments of the third system, the second mobile electronic device is configured to be used in a payment system, and wherein the data uniquely identifying the second mobile electronic device is data configured to be used to execute exchanges of funds in the payment system.

In some embodiments of the third system, in response to detecting the first input, the system executes a payment, via the payment system, to the second mobile electronic device.

In some embodiments of the third system, an amount of funds for the payment is determined in accordance with the time of the exchange of information.

In some embodiments, a third method for verifying presence of a worker at a work site is provided, the third method performed at a system comprising: a first mobile electronic device associated with the work site, wherein the first mobile electronic device comprises a display, an input device, and a first near-field communication device; and a second mobile electronic device associated with the worker, wherein the second mobile electronic device is comprises a second near-field communication device; wherein the first and second mobile electronic devices are configured to exchange information via near-field communication with one another, wherein the information comprises data uniquely identifying the second mobile electronic device associated with the worker; and wherein the third method comprises: in response to detecting the exchange of information, displaying, by the first mobile electronic device, an interface prompting a user of the first mobile electronic device to confirm the presence of the worker at the work site; detecting, via the input device, a first input confirming the presence of the worker at the work site; and in response to detecting the first input, generating, by the first mobile electronic device, an entry for storage in a database indicating that the worker is present at the work site at a time of the exchange of information.

In some embodiments, a third non-transitory computer readable storage medium for verifying presence of a worker at a work site, the third non-transitory computer-readable storage medium storing instructions configured to be executed by a system comprising: a first mobile electronic device associated with the work site, wherein the first mobile electronic device comprises a display, an input device, and a first near-field communication device; and a second mobile electronic device associated with the worker, wherein the second mobile electronic device is comprises a second near-field communication device; wherein the first and second mobile electronic devices are configured to exchange information via near-field communication with one another, wherein the information comprises data uniquely identifying the second mobile electronic device associated with the worker; and wherein execution of the instructions by one or more processors of the first mobile electronic device causes the first mobile electronic device to: in response to detecting the exchange of information, display an interface prompting a user of the first mobile electronic device to confirm the presence of the worker at the work site; detect, via the input device, a first input confirming the presence of the worker at the work site; and in response to detecting the first input, generating an entry for storage in a database indicating that the worker is present at the work site at a time of the exchange of information.

In some embodiments, any one or more of the features, characteristics, or elements discussed above with respect to any of the embodiments may be incorporated into any of the other embodiments mentioned above. In some embodiments, any one or more of the features, characteristics, or elements discussed elsewhere in this disclosure may be incorporated into any one or more of the embodiments mentioned above.

### BRIEF DESCRIPTION OF THE DRAWINGS

FIG. 1 illustrates a system for construction planning, execution, and verification, in accordance with some embodiments.

FIG. 2 illustrates a method for verifying completion of a construction task, in accordance with some embodiments.

FIG. 3 illustrates a method for facilitating payment using a digital wallet, it accordance with some embodiments.

FIG. 4 illustrates a method for verifying worker presence at a construction work site, in accordance with some embodiments.

FIG. 5 illustrates a graphical user interface for controlling a digital wallet in a platform for facilitating construction, in accordance with some embodiments.

FIG. 6 illustrates a computer, in accordance with some embodiments.

### DETAILED DESCRIPTION

Described below are exemplary embodiments of systems, methods, techniques, and graphical user interfaces for planning, executing, and verifying construction tasks, particularly in informal, incremental, and/or small-scale construction markets. As described above, the systems described in detail herein may provide a mobile application interface that allows workers, contractors, homeowners/families/purchasers, and other parties to small-scale and incremental construction projects to connect to one another via one or more network communication interfaces. Using the connected interface to communicate via the systems disclosed herein, parties may collaborate efficiently, effectively, and securely to execute contracting for, monitoring of, and payment for construction projects. Exemplary systems, methods, techniques, and graphical user interfaces are described in greater detail below with reference to the figures.

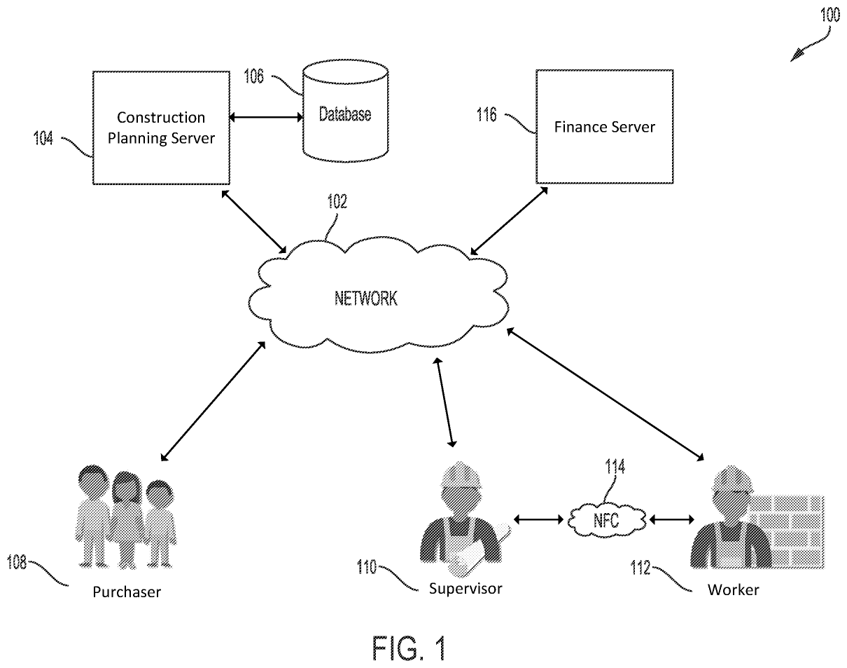

FIG. 1 illustrates system 100 for construction planning, execution, and verification, in accordance with some embodiments. As described above and in further detail herein, system 100 may be a network-connected system for providing a platform for planning, executing, and verifying completion of construction tasks, particularly in the incremental, informal, and small-scale construction sectors in developing countries. System 100 may be configured to provide a mobile application and/or desktop computer interface (or an electronic user interface of any suitable type) that are accessible by various stakeholders to the construction sector. In some embodiments, stakeholders may include homeowners, families, other purchasers or parties contracting for construction tasks, contractors, construction supervisors, construction workers (including formal and/or informal construction workers), architects, suppliers or construction and/or building equipment, and/or lenders.

In some embodiments, any stakeholder to a construction project or construction task may be a user of system 100, and in some embodiments system 100 may be configured to provide different capabilities, features, and interfaces configured for use by different kinds of stakeholders. For example, system 100 may be configured to provide a first set of capabilities, features, and/or interfaces configured to use by families, to provide a second set of capabilities, features, and/or interfaces for use by contractors and supervisors of construction tasks, and to provide a third set of capabilities, features, and/or interfaces for use by construction workers. In some embodiments, capabilities, features, and/or interfaces may be exclusively provided for use by one kind of stakeholder/user, while in some embodiments certain capabilities, features, and/or interfaces may overlap between different kinds of stakeholders/users.

As shown in FIG. 1, network 102 may connect various components of system 100 with one another via network communication. In some embodiments, network 102 may be any suitable computer network, such as a wide-area network or the internet. As shown in FIG. 1, network 102 may be communicatively coupled to construction planning server 104, purchaser 108, supervisor 110, worker 112, and finance server 116. With regard to purchaser 108, supervisor 110, and worker 112, network 102 may be communicatively coupled with network-enabled electronic devices respectively associated with one of the three parties, such as a mobile electronic device, smart phone, tablet device, laptop, desktop computer, or the like. Each of the components connected to network 200, and certain functionalities of each component will be described below.

As mentioned above, purchaser 108, supervisor 110, and worker 112 may each be stakeholders/users in system 100, and may each be connected to system 100 via respective network-enabled electronic devices, such as desktop computers, laptop computers, tablets, smart-phones, or the like. In some embodiments, a network-enabled electronic device connecting a user to system 100 through network 102 may comprise a display for displaying a graphical user interface of system 100, one or more input devices (such as a mouse, keypad, and/or touch-sensitive surface) for receiving inputs from a user, and one or more sensors for detecting one or more characteristics of an environment. In some embodiments, the one or more sensors included in the network-enabled electronic devices may include an image sensor such as a camera, which may be used to capture photographs that may be used in monitoring construction tasks. In some embodiments, the one or more sensors included in the network-enabled electronic devices may include a position sensor such as a GPS sensor, which may be used to capture position data to verify worker presence during construction projects and/or to generate geographic metadata that may be used to help verify the authenticity of photographs that may be used to verify satisfactory completion of construction tasks.

In some embodiments, the network-enabled electronic devices may be configured to communicate via one or more network communication protocols, such as via cellular data, Wi-Fi, Bluetooth, near-field communication (NFC), or any other suitable network communication protocol. As shown in the example of FIG. 1, each of the network-enabled electronic devices associated with purchaser 108, supervisor 110, and worker 112 is configured to be communicatively coupled with network 102, such as via a cellular data connection, via Wi-Fi, or via a wired internet connection. As further shown, the network-enabled electronic devices associated with supervisor 110 and worker 112 are further configured to be communicatively coupled with one another via NFC, such that they may exchange information with one another when the devices are within a sufficient physical proximity to one another.

As shown in FIG. 1, system 100 may allow communication by each user/stakeholder with construction planning server 104. Server 104 may be a server comprising one or more processors configured to execute any one or more of the methods and techniques disclosed herein, including but not limited to storing and executing instructions for providing a platform and/or various user interfaces, accessible by users/stakeholders, for planning, executing, and monitoring construction projects. Server 104 may be configured to store and execute instructions, to receive information regarding inputs from users, to send information to users, and to facilitate the exchange of information between other components of system 100.

In some embodiments, server 104 may be communicatively coupled to one or more computer storage devices, such as database 106. In some embodiments database 106 may be configured to store data used in providing the building planning platforms described herein. For example, database 106 may in some embodiments store information about users of the platform.

In some embodiments, database 106 may store information about construction projects (past, present, and future), such as time, location, and parties to the construction project. In some embodiments, database 106 may store information about milestones for a construction project, verification of milestones, and payments to be associated with completion and verification of the one or more milestones. A milestone may be any user-defined or predefined construction task (e.g., building a house, building a wall, hanging drywall, painting a wall, working for a certain number of hours or days, etc.) and may be associated in system 100, via one or more entries stored in database 106, with payments to be made to contractors and/or workers only upon verified completion of the milestone, as discussed below in further detail.

In some embodiments, all transfers of funds inside the platform itself (e.g., internal transfers, as opposed to deposits or withdrawals to or from an outside financial institution) must be associated with a defined construction task or project. In some embodiments, users may not be permitted to transfer funds between different wallets or accounts inside the platform unless the transfer is linked to data associated with a construction task stored in a database associated with the platform.

In some embodiments, database 106 may store information about funds available to one or more users of the system and/or allocated toward or associated with one or more construction projects or construction tasks stored in the system. For example, as discussed in greater detail below, users may control private digital wallets accessible through the system, and may fund those wallets with money deposited from outside financial institutions and/or payment systems. Users may further use system 100 to allocate funds from their digital wallets toward completion of a construction task, including by putting funds into an escrow account maintained by system 100, payment from which may be indicated in database 106 as being contingent upon verified completion of the construction task. Balances of available funds for users, as well as amounts of funds associated with various construction projects and/or tasks, as well as amounts of funds in one or more escrow accounts, may be represented by entries stored in database 106

As shown in FIG. 1, system 100 may further comprise finance server 116, which may be any server associated with a public or private payment system, money transfer system, financing service, or microfinancing service, such as any bank, electronic money-transfer institution, or other entity configured to electronically transfer funds into or out of a digital wallet of system 100. In some embodiments, finance server 116 may allow users to load (e.g., deposit) funds into a digital wallet of the platform via a checking account, savings account, bank card, credit card, debit card, gift card, prepaid card, or the like. In some embodiments, finance server 116 may be a server associated with a “mobile money” service provided by a private institution other than a bank, such as a mobile money service provided by a wireless service provider. For example, finance server 116 may be a server associated with the M-PESA mobile phone-based money transfer system, which has a higher consumer penetration in certain developing countries than traditional banking services.

In any event, server 116 may comprise one or more processors configured to receive and send messages via network 102 in order to facilitate the transfer of funds into and out of a separate funding system maintained by server 104. Thus, all digital wallet funds for use in the construction platform provided by system 100 may be maintained by server 104, while funds maintained by server 116 may be external to the construction platform provided by system 100.

In some embodiments, transfer of funds between finance server 116 and server 104 may be executed by use of unique identification codes, such as paybill numbers used by mobile phone-based money transfer systems such as M-PESA. In some embodiments, a first single paybill number (or other first unique identification code) may be assigned to transfer of funds from finance server 116 to server 104, which a second single paybill number (or other second unique identification code) may be assigned to transfer of funds from server 104 to finance server 116. Thus, in some embodiments, when any user of system 100 wishes to transfer funds into their digital wallet in system 100, they may use the first single paybill number to do so; and when any user of system 100 wishes to transfer funds out of their digital wallet in system 100, they may use the second single paybill number to do so.

In some embodiments, when a single deposit paybill number and a single withdrawal paybill number are used for all (or for any set greater than one) of the users of the construction platform of system 100, records of the amounts of funds in each user's individual digital wallet may be maintained by data stored in database 106. In some embodiments, transactions, amounts of funds available to one or more users in system 100, and/or amounts of funds committed to or associated with one or more construction projects or tasks stored in system 100, may be maintained using one or more distributed accountability systems, including but not limited to a distributed ledger system such as blockchain.

In some embodiments, the platform provided to users by system 100 may allow users to access a mobile application that includes one or more application interfaces usable by various parties to small-scale and/or incremental construction.

Among other functionalities that may be provided to users of the platform provided by system 100, users may be able to create and define construction projects to be stored in system 100, such as by creating, storing, and/or publishing a construction project for building a family home for a purchaser. Other users of the system may then be able to view the project that has been created and stored in the system, such that other users may communicate with the project creator regarding execution of the project.

A project creator may define, store, and/or publish one or more construction tasks (e.g., build a new home, build an expansion onto an existing home, paint a wall of an existing home, etc.) and to store data in system 100 regarding payment for completion of the construction tasks. When a contractor or builder agrees with a purchaser (e.g., homeowner) regarding a payment amount for a construction task, funds for the task may, in some embodiments, be transferred from the purchaser's digital wallet in system 100 to an escrow account maintained by system 100 (e.g., maintained by server 104). After completion of the construction task, the contractor/worker may use the platform to electronically send an indication of completion of the task to the purchaser, and the purchaser may verify satisfactory completion of the task, for example on the basis of photographs of the completed task uploaded by the contractor/worker through the platform. Only upon verification of completion of the tasks may the escrowed funds be released to the contractor/worker.

It should be noted that, in some embodiments, certain tasks, milestones, or events may be configured in the system to trigger exchanges of funds directly between two users (e.g., exchanges of funds directly between two private digital wallets in the system), while other tasks, milestones, or events may be configured to trigger exchanges of funds using escrow accounts, intermediate accounts, or funds otherwise held or allocated in advance of completion of the event. In some embodiments, users of the system (e.g., a user defining a construction task as discussed below) may indicate whether direct or indirect funds transfers should be used for a specific construction task. In some embodiments, direct transfers may be used for certain kinds of construction tasks (e.g., hourly work payments) but not others; in some embodiments, direct transfers may be used for construction tasks where the payment is below a predefined or user-defined threshold, while escrowed payment may be used for construction tasks where the payment is greater than a predefined or user-defined threshold.

Thus, the platform and interfaces provided by system 100 may allow for geographically remote users of the system to securely and efficiently plan, execute, and verify completion of construction tasks, including construction tasks in the incremental, small-scale, and informal construction sectors.

Among other functionalities that may be provided to users of the platform provided by system 100, users may be provided the option to fund digital wallets in the system using any one of a plurality of payment methods, including by electronically linking to banking services, financing services, microfinancing services, payment services, prepaid card services, credit card services, debit card services, or the like. In some embodiments, the platform provided by system 100 may allow users to fund a private digital wallet through use of an identification code for executing money transfers (e.g., a paybill number) using a mobile phone-based money transfer service such as M-PESA. In some embodiments, the interfaces provided by system 100 may allow a user to deposit or withdraw funds from a digital wallet maintained by server 104 using an identification code for executing money transfers, wherein the user is not required to manually execute or otherwise manually indicate the identification code. For example, system 100 may be configured such that deposit requests and withdrawal requests made by users automatically call a corresponding associated identification code to execute the deposit or withdrawal. Thus, the platform and interfaces provided by system 100 may improve usability, efficiency, and accessibility of secure digital exchange of funds for stakeholders in the small-scale and informal construction sectors in developing countries without robust formal banking or financing systems.

Among other functionalities that may be provided to users of the platform provided by system 100, contractors and supervisors of construction projects utilizing informal construction workers may be able to use the platform of system 100 to track and account for the time spent working by members of the informal workforce. In some embodiments, mobile devices (e.g., smart phones) using the mobile application provided by system 100 may be configured to use NFC to communicate with one another, such that a supervisor's mobile device and a worker's mobile device may exchange information with one another. This information may be used to automatically account for the worker's presence at a work site, or to account for the worker's presence at the site if certain conditions are satisfied, or to prompt the supervisor to verify the worker's presence at the site. In addition to providing an accountable and reliable way for workers to clock in and clock out of a work site, the platform provided by system 100 may further leverage the clock-in and clock-out information to compile hours sheets for workers and to enable supervisors/contractors to accurately and efficiently pay worker using the platform itself, for example by transferring funds to a digital wallet of a worker using the platform. Thus, the platform and interfaces provided by system 100 may improve reliability, accuracy, and consistency of worker-tracking systems used in informal, small-scale, and/or incremental construction sectors in developing countries.

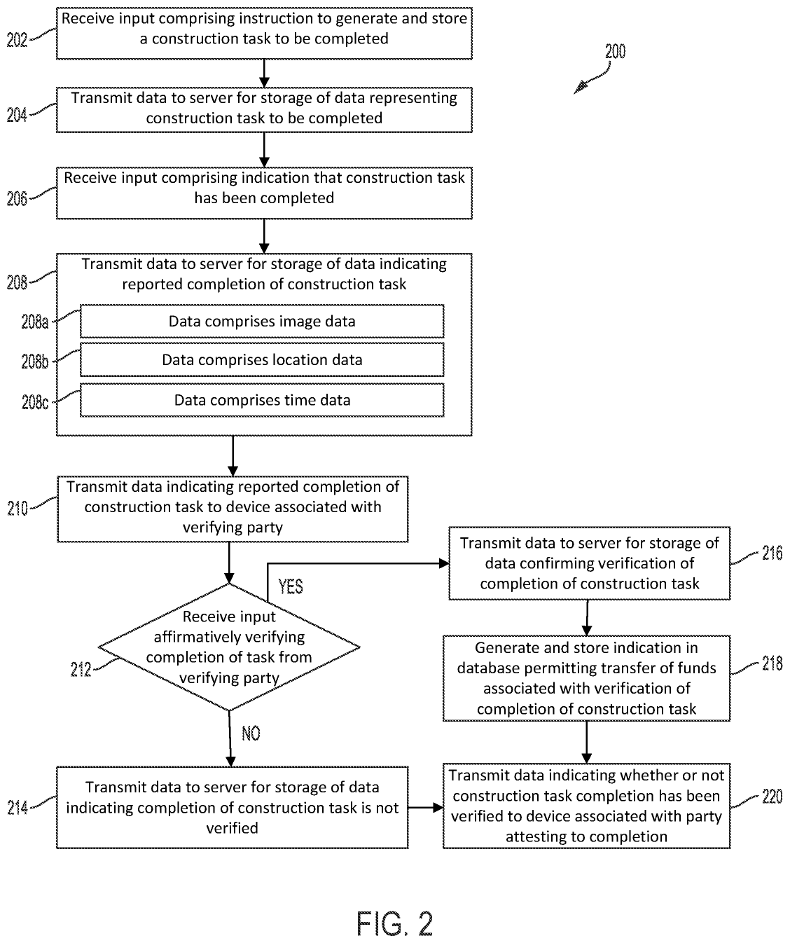

These functionalities, along with related functionalities, that may be provided by the platform of system 100, are discussed in further detail with respect to FIGS. 2-4 below. Each of FIGS. 2-4 depicts a respective flowchart describing an exemplary method performed by a system for planning, execution, and verification of construction projects and tasks, such as by system 100 as described above. In some embodiments, one or more features or aspects of the methods described below with respect to FIGS. 2-4 may be combined with one another, or may be combined with any other teaching disclosed herein.

FIG. 2 illustrates a method 200 for verifying completion of a construction task, in accordance with some embodiments. In some embodiments, method 200 may be performed by a computerized system for planning, execution, and verification of construction projects and tasks, such as system 100 as described above with respect to FIG. 1. In the context of this description, it is contemplated that system 100 provides a platform including desktop and mobile application graphical user interfaces accessible by users of system 100, and that the users of system 100 use the graphical user interfaces to access the system and cause the system to execute the method steps described herein.

At block 202, the system receives an input comprising an instruction to generate and store a construction task to be completed. The input may be executed by a user, and may take the form of an electronic message or transmission received by the system from an external device, or may take the form of a physical input detected by an input device or sensor of the system itself. In some embodiments, the input may be a set of one or more taps or presses executed against a touch-screen graphical user interface of a mobile application.

In some embodiments, the input may comprise an indication of any one or more of the following:
the nature of the construction task (e.g., what should be built, repaired, painted, improved, renovated, etc.; how many hours should be worked; what construction project, if any, is the construction task a part of; etc.);
location data for the construction task (e.g., where is the work site, zoning data for the work site, etc.);
time data for the construction task (e.g., when should the task begin, when should the task be completed by, etc.);
specifications for the construction task (e.g., architectural plans/drawings, dimensions, measurements, characteristics, materials to be used, building standards to be met, etc.);
data regarding parties to the construction task (e.g., who is paying for or financing the task, who owns the work site, who operates the work site, who may work on the task, etc.);
data regarding payment for the construction task (e.g., how much will the purchaser pay for completion of the task, how will payment be made, when will payment be made, on what conditions will payment be made, etc.);
data regarding verification of completion of the construction task (e.g., who will verify completion of the task, how will verification of completion of the task be made, etc.); and
data regarding privacy/visibility of the construction task (e.g., what users of the system will be able to view what information about the task).

Any of the information indicated above may be included in the input executed by a user; for example, a user may select predefined menu options, type information into text fields, upload architectural plans from a device used by the user to access the mobile application, select from a menu of predefined architectural plans, and/or indicate locations on using a map interface.

In some embodiments, a construction task may be defined and stored/saved to the system by a user. For example, a homeowner may define a construction task for building a wall at his home. In some embodiments, construction tasks may be defined and stored/saved to the system as part of a larger construction project involving a plurality of construction tasks. For example, the task for building the wall at the homeowner's home may be part of a larger construction project for completing various improvements (e.g., incremental improvements) to the homeowner's home.

At block 204, the system transmits data from a mobile electronic device to a remote server, wherein the transmission of data causes the server to store data representing the construction task to be completed. (While the discussion of method 200 refers to an exemplary mobile electronic device, it should be understood that the systems and techniques taught herein with respect to mobile electronic devices may be equally applicable, in some embodiments, when implemented via any suitable electronic device, such as a network-enabled desktop computer, laptop computer, tablet, or the like. This principle may be equally applicable to other instances in which method 200 refers to a mobile electronic device or to any electronic device, and to other instances in which any method, technique, or system disclosed herein refers to a mobile electronic device or to any electronic device.) In some embodiments, this transmission may be undertaken in response to detecting the input at block 202, or in response to receiving a separate instruction from a user of the system to transmit the data. In some embodiments, the mobile electronic device may be a desktop computer, laptop computer, or mobile device (e.g., smartphone) used by a user of the system to enter the information discussed at block 202. For example, the device may be a device of purchaser 108 in system 100, and the server may be server 104 in system 100. The mobile electronic device of purchaser 108 may then transmit the data via network 102 to server 104, wherein the transmission of data causes server 104 to store data representing the construction task to be completed.

In some embodiments, the data stored may be stored in a database such as database 106. The data may be stored as a database entry including one or more fields indicating any one or more pieces of information about the construction task, including any of the information discussed above with respect to block 202. In some embodiments, the data may be stored in such a manner so as to be visible to one or more users of system 100 in addition to the user who uploaded the information about the construction task. For example, metadata stored with or in association with the data may indicate what users (or what types of users) may view the stored construction task.

In this manner, in some embodiments, once a construction task is uploaded, the task may be visible to one or more users of system 100 who may work toward completion of the task. For example, in an instance in which a purchaser uploads a construction task, one or more contractors may view the task to provide quotes, bids, offers, or other information to the purchaser regarding completion of the task. In an instance in which a purchaser or contractor/supervisor (e.g., supervisor 110) uploads a construction task for a preexisting or ongoing construction project, one or more workers (e.g., worker 112) may view the task using an interface of system 100 in order to know what work needs to be done on the project, when, where, and in what manner. Thus, defining and uploading/publishing construction tasks may allow purchasers to solicit bids for construction tasks, may allow homeowners to instruct contractors or workers regarding tasks to be completed in ongoing projects, and may allow supervisors to instruct workers regarding tasks to be completed in ongoing projects.

At block 206, the system receives input comprising an indication that the construction task has been completed. The input may be executed by a user, and may take the form of an electronic message or transmission received by the system from an external device, or may take the form of a physical input detected by an input device or sensor of the system itself. In some embodiments, the input may be a set of one or more taps or presses executed against a touch-screen graphical user interface of a mobile application.

In some embodiments, the input may comprise an indication that the task is completed, when the task was completed, by whom the task was completed, and/or any additional information (e.g., notes, etc.) about the manner in which the task was completed. Any of that information about completion of the task may be included in the input executed by a user; for example, a user may select predefined menu options, type information into text fields, upload images of the completed task, upload or capture or otherwise input location data related to the completed task, and/or upload or capture or otherwise input time data related to the completed task.

In some embodiments, information indicating completion of a construction task may be input to system 100 by a user who worked on or oversaw completion of the task. For example, supervisor 110 and/or worker 112 in system 100 may use their respective mobile electronic devices to enter information regarding completion of the construction task (e.g., to select an interface object to mark the task as completed) and/or to enter or upload any information associated with marking a task as completed (e.g., photographs of the completed task, certificates, etc.).

At block 208, the system transmits data from a mobile electronic device to a remote server, wherein the transmission of data causes the server to store data indicating the reported completion of the construction task.

In some embodiments, this transmission may be undertaken in response to detecting the input at block 206, or in response to receiving a separate instruction from a user of the system to transmit the data. In some embodiments, the mobile electronic device may be a desktop computer, laptop computer, or mobile device (e.g., smartphone) used by a user of the system to enter the information discussed at block 206. For example, the device may be a device of supervisor 110 or of worker 112 in system 100, and the server may be server 104 in system 100. The mobile electronic device of supervisor 110 or of worker 112 may then transmit the data via network 102 to server 104, wherein the transmission of data causes server 104 to store data indicating and regarding the completion of the construction task.

At block 208a, the data indicating the reported completion of the construction task comprises image data, including but not limited to photographs of the construction task documenting progress and completion of the task. In some embodiments, such photographs may be captured by a user uploading the data at block 208. In some embodiments, a user interface of system 100 may automatically prompt a user to attach/upload a photograph or to capture a photograph in response to the user indicating that he wishes to indicate completion of a task. In some embodiments, whether system 100 automatically prompts or requires a user to include a photograph of the completed task may be determined in accordance with data stored in association with the construction task, such as data indicating whether (and/or what kind of) documentary evidence of completion is required.

At block 208b, the data indicating the reported completion of the construction task comprises location data. In some embodiments, location data may comprise data manually entered by a user indicating a location of completion of the task, it may comprise data read from preexisting data about a location of the construction task or a work site associated with the task, and/or it may comprise data captured by a sensor of a device of the user reporting completion of the construction task. For example, in some embodiments, a device of a user reporting completion of a construction task may be automatically caused by system 100 to capture location data, such as GPS data captured by a GPS sensor of the user's mobile device, upon indication of completion of the task or upon uploading information regarding completion of the task. In some embodiments, the location data may comprise geographic metadata associated with the image data discussed above, such as a geographic tag associated with a photograph of the completed task.

At block 208c, the data indicating the reported completion of the construction task comprises time data. In some embodiments, time data may comprise data manually entered by a user indicating a date and/or time of completion of the task, it may comprise time read from preexisting data about a schedule or deadline of the construction task, and/or it may comprise data generated by a device of the user reporting completion of the construction task. For example, in some embodiments, a device of a user reporting completion of a construction task may be automatically caused by system 100 to record time data, such as a date and time of the indication of completion, upon indication of completion of the task or upon uploading information regarding completion of the task. In some embodiments, the time data may comprise time metadata associated with the image data discussed above, such as a date and/or time at which a photograph of the completed task was captured.

In some embodiments, the data regarding completion of the task may be stored by system 100 in a database such as database 106. The data may be stored as a database entry including one or more fields indicating any one or more pieces of information about the construction task, including any of the information discussed above with respect to block 206. In some embodiments, the data may be stored in such a manner so as to be visible to one or more users of system 100 in addition to the user who uploaded the information about completion of construction task. For example, metadata stored with or in association with the data may indicate what users (or what types of users) may view the information regarding completion of construction task. In some embodiments, the information regarding completion of the construction task may only be visible to certain users of system 100, such as the user who created the construction task, the user who purchased the construction task, workers at a work site of the construction task, and/or any one or more other parties associated in system 100 with the construction task.

In some embodiments, the data stored regarding completion of the construction task may be stored by creating new database field, by storing data to previously unused database fields, and/or by modifying data in preexisting database fields (e.g., changing a stored flag for the construction task from “incomplete” to “complete”).

In this manner, in some embodiments, once a construction task is completed, information regarding completion of the task may be visible to one or more users of system 100 who may have an interest in viewing and/or verifying completion of the construction task. For example, in an instance in which financing or payment is contingent on completion of a construction task, parties responsible for financing and/or payment may view the uploaded information through the platform provided by system 100.

Furthermore, in instances where verification of completion of the construction task is required (e.g., required for payment for the task, for payment of a worker's hourly wages, and/or for release of funds from escrow), the party responsible for verifying completion of the task may use system 100 to verify completion of the task based on the information uploaded, as discussed in further detail below. For example, a supervisor or contractor may be responsible for verifying completion of a construction task once that completion is attested to by a worker. Alternately, a purchaser or homeowner may be responsible for verifying completion of a construction task once that completion is attested to by a contractor, supervisor, or worker.

Thus, uploading and publishing information regarding completion of construction tasks may allow purchasers and/or supervisors to verify completion of the task on the basis of the uploaded information, and may allow parties involved in paying for or financing the construction task to rely on verification of the completion of the task. In some embodiments, system 100 may allow for this verification to be executed in a distributed manner, such that one or more users may attest to verification of completion of the task, and verification of completion of the task may be carried out by users in geographically remote locations, such as family members working abroad to earn money for construction of a family home in their native country, which is a common arrangement in developing countries.

At block 210, the system transmits, from the server to a mobile electronic device associated with a verifying party, data indicating the reported completion of the construction task. As discussed above a verifying party may be various different parties in accordance with how a construction task or construction project is arranged and defined in system 100. In some embodiments, the verifying party is a purchaser, such as purchaser 108, who may be a homeowner. In the example of system 100, server 104 transmits the data indicating the reported completion of the task to the mobile device of a verifying party, via network 102, whether that verifying party is purchaser 108, supervisor 110, or both.

In some embodiments, this transmission may be undertaken in response to detecting receipt by server 112 of the information attesting to completion at block 208, or in response to receiving a separate instruction from a user of the system to transmit the data, or at a predefined time (e.g., a time of scheduled completion of a task or project). In some embodiments, the mobile electronic device associated with the verifying party may be a desktop computer, laptop computer, or mobile device (e.g., smartphone). For example, the device may be a device of supervisor 110 or of purchaser 108 in system 100, and the server may be server 104 in system 100.

After receiving the transmission of data indicating the reported completion of the construction task, the recipient of that transmission may access one or more graphical user interfaces of the platform provided by system 100 to view information regarding the attested completion, including any image data, location data, time data, and/or other data (e.g., notes from the party attesting to completion) regarding the attested completion of the construction task. On the basis of this information, the verifying party may review the information and make a determination as to whether or not to verify completion of the construction task. As discussed below, the verifying party may execute one or more inputs to indicate whether or not to verify completion of the task.

At block 212, the system receives input from the verifying party either verifying completion of the construction task or rejecting verification of completion of the construction task.

The input may be executed by a user, such as one or more of the verifying users discussed above, and may take the form of an electronic message or transmission received by the system from an external device, or may take the form of a physical input detected by an input device or sensor of the system itself. In some embodiments, the input may be a set of one or more taps or presses executed against a touch-screen graphical user interface of a mobile application.

In some embodiments, the input may comprise an indication that completion of the task is verified, an indication that completion of the task is not verified, as well as any additional information (e.g., notes) entered or uploaded by a user regarding the verification or rejection (e.g., declining to verify) of completion of the task. Any of that information about verification or rejection of the attested completion of the task may be included in the input executed by a user; for example, a user may select predefined menu options, select one or more buttons, operate one of more GUI objects such as a toggle switch or a check-box, or type information into one or more text fields.

Following detection of the input either verifying or rejecting completion of the task, the system may determine whether the input (a) verifies completion or (b) rejects completion or does not verify completion. In some embodiments, this determination may be made by the system at a device local to the input, such as at a mobile device of a user who enters the input. In some alternate embodiments, this determination may be made by a central server such as server 104 of system 100. In either event, data regarding the verification or rejection of completion of the construction task may be transmitted from the device into which the input was entered to a central server of the system, such as server 104. Below, different operations are discussed for the separate cases in which the verifying user's input does or does not verify completion of the task.

At block 214, if the system has received input from the verifying party rejecting verification of completion of the construction task, the system transmits data to the server, wherein the transmission of data causes the server to store data indicating completion of the construction task is not verified. In the example of system 100, server 104 may receive transmission of the verification data from the mobile device of a verifying party, via network 102, whether that verifying party is purchaser 108, supervisor 110, or both. In some embodiments, this transmission may be undertaken in response to detecting the input of the verification information at block 212, or in response to receiving a separate instruction from a user of the system to transmit the data, or at a predefined time (e.g., a time of scheduled verification, or a verification deadline).

In some embodiments, the data regarding verification of the task may be stored by system 100 in a database such as database 106. The data may be stored as a database entry including one or more fields indicating any one or more pieces of information about the verification, including any of the information discussed above with respect to block 212. In some embodiments, the data may be stored in such a manner so as to be visible to one or more users of system 100 in addition to the user who input and/or uploaded the verification information. For example, metadata stored with or in association with the data may indicate what users (or what types of users) may view the verification data. In some embodiments, the verification information may only be visible to certain users of system 100, such as the user who created the construction task, the user who purchased the construction task, workers at a work site of the construction task, the user who verified or rejected completion of the task, and/or any one or more other parties associated in system 100 with the construction task.

In some embodiments, the verification data may be stored by creating new database field, by storing data to previously unused database fields, and/or by modifying data in preexisting database fields (e.g., by changing a first stored flag for the construction task from “complete” to “verified” or “rejected,” by changing a second stored flag from “unverified” to “verified” or “rejected”).

In this manner, in some embodiments, if attested completion of a construction task is rejected, then information regarding that rejection may be visible to one or more users of system 100 who may have an interest in viewing information about the rejection. For example, in an instance in which financing or payment is contingent on verification of completion of a construction task, parties responsible for financing and/or payment may view the uploaded verification information through the platform provided by system 100 in order to know that funds should be withheld if completion is not verified. In another example, a contractor, supervisor, or worker may be able to view information about rejection of the construction task such that they may remediate any issues that caused the rejection and re-submit the verification request once any issues have been remediated.

Thus, uploading and publishing verification information may allow contractors, supervisors, and/or workers to know whether completion of a task has been verified, and may allow those parties to work to remediate any construction task for which verification has been denied. Furthermore, it may allow parties to know that payment for completion of the construction task may or should be withheld until issues with the construction task are remediated and verification is confirmed.

Proceeding alternately from block 212, at block 216, if the system has received input from the verifying party verifying completion of the construction task, the system transmits data to the server, wherein the transmission of data causes the server to store data indicating verification of completion of the construction task. In the example of system 100, server 104 may receive transmission of the verification data from the mobile device of a verifying party, via network 102, in a same or similar manner as discussed above with respect to the verification information at block 214.

In some embodiments, the data regarding verification of the task may be stored by system 100 in a database such as database 106, in a same or similar manner as discussed above with respect to the storage of verification data at block 214.

In this manner, in some embodiments, if attested completion of a construction task is verified, then information regarding that verification may be visible to one or more users of system 100 who may have an interest in viewing information about the verification. For example, in an instance in which financing or payment is contingent on verification of completion of a construction task, parties responsible for financing and/or payment may view the uploaded verification information through the platform provided by system 100 in order to know that funds should be dispersed or exchanged in accordance with the verification of completion of the task. In another example, a contractor, supervisor, or worker may be able to view information about verification of completion of the construction task such that they may know that no further work or remediation is required on the task.

Furthermore, in some embodiments, information about completion of a construction task may be used to generate data about overall progress on a construction project to which the task is a component; for example, reports showing an overall percentage of progress for a project, or showing whether a project is on schedule for completion by a predefined deadline, may be generated in part based on data stored in the system about verification of completion of specific construction tasks.

Thus, uploading and publishing verification information may allow contractors, supervisors, and/or workers to know whether completion of a task has been verified, and may allow those parties to know whether any work to remediate any problems or issues is required. Furthermore, it may allow parties to know that payment for completion of the construction task may or should be executed in accordance with verification of completion of the task.

At block 218, in accordance with affirmative verification of completion of the construction task at block 214, the system generates and stores an indication in a database permitting a transfer of funds associated with verification of completion of the construction task. In some embodiments, the data indicating that transfer of finds is permitted may indicate that transfer of funds between two user (e.g., between a homeowner and a contractor) is permitted; in some embodiments, the data indicating that transfer of finds is permitted may indicate that transfer of funds from an escrow account to a wallet of a user of the system is permitted.

In some embodiments, the data may be stored by system 100 in a database such as database 106. The data may be stored as a database entry including one or more fields indicating any one or more pieces of information about permitting transfer of funds. In some embodiments, the data may be stored in a database that maintains records of finds available to different users of the platform provided by system 100, such as funds in various specific users' digital wallets in the system, as discussed elsewhere herein. In some embodiments, funds deposited into the platform provided by system 100 may be maintained in different accounts and/or wallets by one or more database designations stored by server 104, such as designations stored by server 104 in database 106.

In some embodiments, the data may be stored by creating new database field, by storing data to previously unused database fields, and/or by modifying data in preexisting database fields (e.g., by changing a stored flag for the release of escrowed funds from “pending” to “approved”).

In some embodiments, funds deposited into the platform provided by system 100 may be tracked, monitored, and/or maintained using one or more distributed accountability systems, including but not limited to a distributed ledger system such as blockchain.

In some embodiments, the data may be stored in such a manner so as to be visible to one or more users of system 100. For example, data regarding distribution or exchange of funds upon verification of completion of a project may be visible through system 100 to a purchaser paying for the task, a contractor being paid for the task, a worker being paid for the task, one or more parties otherwise associated with the task or with a work site of the task, and/or one or more parties otherwise associated with financing of the task or of a larger project with which the task is associated.

At block 220, the system transmits, to a mobile electronic device associated with the party that initially attested to completion of the construction task, data indicating whether or not completion of the construction task has been verified by the verifying party. In some embodiments, system 100 may simply store the indication regarding verification, such as by storing it in database 106, and may allow users to access the information regarding verification manually. However, in some embodiments, system 100 may automatically push a notification or other transmission regarding verification or rejection to one or more users, such as to the user who initially attested to completion of the construction task.

In some embodiments, the transmission to the attesting user may be carried out in a same or similar manner as any one or more of the other transmissions discussed herein, such as by sending data from server 104 to a mobile device of the user, such as a mobile device of supervisor 110 or worker 112.

As discussed above, the user who initially executed an input to mark the task as complete may have various interests in knowing whether completion of the task has been verified or rejected, including so that the user can know whether remediation is required, whether further work is required, whether payment is being withheld, or whether payment is being executed. Thus, automatically transmitting this information to the user or users who initially attested to completion of the task may improve efficiency of the construction project.

Thus, method 200 provides a method for harnessing systems, such as system 100, to create, monitor, and verify completion of construction tasks in an efficient and reliable manner in the informal construction sector in developing countries.

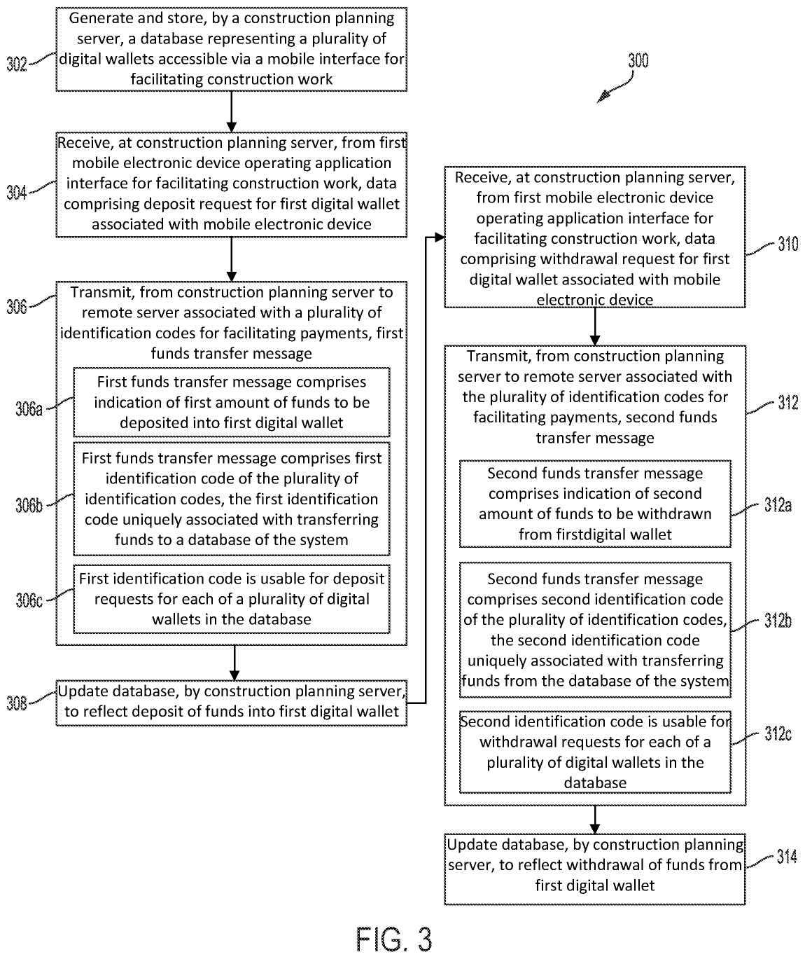

FIG. 3 illustrates a method 300 for facilitating payment using a digital wallet, it accordance with some embodiments. In some embodiments, method 300 may be performed by a computerized system for planning, execution, and verification of construction projects and tasks, such as system 100 as described above with respect to FIG. 1. In the context of this description, it is contemplated that system 100 provides a platform including desktop and mobile application graphical user interfaces accessible by users of system 100, and that the users of system 100 use the graphical user interfaces to access the system and cause the system to execute the method steps described herein.

Method 300 describes techniques for depositing and withdrawing funds from a digital wallet that may be used as part of a construction planning platform and interface, such as the platforms and interfaces described herein as provided by system 100. For example, users of system 100 may be able to fund and control private digital wallets that are maintained within the platform, such that they may use funds from the digital wallets to pay for or receive payment for construction tasks projects carried out using the platform. Because the platforms described herein may be particularly suitable for use in the incremental, small-scale, and informal construction markets in developing countries, the digital wallet functionality of the platform provided by system 100 may be configured such that it may be compatible with mobile phone-based money transfer systems, such as M-PESA, which have far higher penetration rates than formal banking systems in some developing countries. Thus, method 300 describes techniques for depositing and withdrawing funds from a digital wallet that may be used as part of a construction planning platform and interface, including with mobile phone-based money transfer systems, such as M-PESA.

At block 302, the system generates and stores, by a construction planning server, a database representing a plurality of digital wallets accessible via a mobile application interface for facilitating construction work. In some embodiments, the construction planning server may be any server configured to store and/or execute a construction planning platform such as the platforms discussed herein, and/or to provide one or more graphical user interfaces for facilitating construction work to network-enabled devices connected to the construction planning server. In the example of system 100 in FIG. 1, the construction planning server may be server 104 connected by network 102 to various other system components.

In some embodiments, the database generated and stored may be stored in any suitable computer storage medium, including but not limited to a database such as database 106 in system 100. In some embodiments, the database generated and stored may be a database maintaining funds in a plurality of digital wallets, wherein each of the plurality of digital wallets is associated with one or more users of the platform provided by the system. Herein, the database maintaining funds in the platform provided by system 100 may be referred to as a digital wallet database. In addition to maintaining funds in a plurality of digital wallets, a digital wallet database may also maintain funds in one or more non-wallet accounts, such as funds maintained in escrow accounts that are not included in any one user's digital wallet.

In some embodiments, fund allocation may be maintained in the digital wallet database in accordance with any suitable database structure, such that information stored in the database may be created, modified, augmented, and/or deleted by system 100 (e.g., by server 104) in order to represent deposits of funds into wallets or accounts, withdrawals of funds out of wallets or accounts, and/or movement of funds between wallets and/or accounts. By executing changes against the digital wallet database, an internal server of system 100, such as server 104, may thus effect changes to balances of one or more wallets within the system, without the need to send or receive any funds to or from outside or independent financial institutions or services.

Blocks 304-314, on the other hand, relate to techniques for sending funds between an outside financial institution or service and the digital wallet system provided by the platform of system 100. As mentioned above, the outside financial institution or service may be associated with any public or private payment system, money transfer system, financing service, microfinancing service, bank, electronic money-transfer institution, and/or other entity configured to electronically transfer funds into or out of a digital wallet provided by the construction planning platform of system 100.

At block 304, the system receives, at the construction planning server, from a first mobile electronic device operating the application interface for facilitating construction work, data comprising a deposit request for a first digital wallet associated with the mobile electronic device. (While the discussion of method 300 refers to an exemplary mobile electronic device, it should be understood that the systems and techniques taught herein with respect to mobile electronic devices may be equally applicable, in some embodiments, when implemented via any suitable electronic device, such as a network-enabled desktop computer, laptop computer, tablet, or the like. This principle may be equally applicable to other instances in which method 300 refers to a mobile electronic device or to any electronic device, and to other instances in which any method, technique, or system disclosed herein refers to a mobile electronic device or to any electronic device.) In some embodiments, the data may be received via any suitable form of network communication, including transmission over one or more wired or wireless electronic communication mediums and/or computer networks.

In some embodiments, the first mobile electronic device may be any mobile electronic device used by a user of the system, such as a mobile electronic device used by purchaser 108 in system 100, and may be received by server 104 via transmission over network 102. In some embodiments, the data may be received from a laptop computer or desktop computer.

In some embodiments, the data received from the first mobile electronic device may indicate an amount of funds to be deposited into a the first digital wallet, an indication of the identity of the first digital wallet, an indication of one or more sources from which the finds should be drawn, and/or an indication of a time at which the deposit should be executed.

At block 306, the system transmits, from the construction planning server to a remote server associated with a plurality of identification codes for facilitating payments, a first funds transfer message. Herein, the remote server associated with a plurality of identification codes for facilitating payments may be referred to simply as a finance server. In some embodiments, the finance server may be finance server 116 is system 100, and may receive the finds transfer message from server 104 via network communication over network 102.

In some embodiments, the transmission of the first funds transfer message may be executed by the system (e.g., by server 116) in response to the system receiving the deposit request from the user, as discussed above at block 304. In some embodiments, the first funds transfer message may be sent immediately upon receiving the deposit request, upon the satisfaction of one or more predefined conditions, and/or at a predefined or user-specified time.

At block 306a, the first funds transfer message comprises an indication of a first amount of funds to be deposited into the first digital wallet. In some embodiments, this first amount of funds is an amount that was indicated in the deposit request initiated by the user at the first mobile electronic device.

At block 306b, the first funds transfer message comprises a first identification code of the plurality of identification codes, wherein the first identification code is uniquely associated with transferring funds to a database of the system. In some embodiments, the first identification code may be a code that is usable by a money transfer system or other financial system associated with the finance server to send or receive funds between the finance server and a specific other entity. That is, the first identification code may indicate the entity with which the finance server should exchange funds in accordance with the code, which in the case of block 306b is the construction planning server 104. Furthermore, the first identification code may indicate whether funds should be sent from the finance server to the other entity, or whether funds should be sent from the other entity to the finance server. Thus, in some embodiments, different identification codes may be used for transfers away from the finance server (e.g., deposits into the construction planning server) versus for transfers to the finance server (e.g., withdrawals from the construction planning server). In the case of block 306b and the corresponding deposit request of block 304, the identification code may indicate that funds should be transferred away from finance server 116 and to construction planning server 104.

In some embodiments, the first identification code may be included in the first funds transfer message sent to the finance server without any need for a user of system 100 to manually enter or explicitly indicate the identification code. For example, the first identification code may be automatically called by an API of the platform provided by system 100, such that the first identification code is automatically appended to the first funds transfer message, or otherwise automatically called by the system, in response to a user executing an input indicating a deposit request. Thus, a user may simply indicate an amount of funds to be transferred from a financial service, and select a GUI object to execute the deposit; in response to detecting selection of this GUI object, the system may automatically call the first identification code as part of executing the deposit.

In some embodiments, the first identification code may be a “paybill” number used by a mobile phone-based money transfer systems, such as M-PESA.

At block 306c, the first identification code is usable for deposit requests for each of a plurality of digital wallets in the database. That is, in some embodiments, the same first identification code may be used to effect transfers of funds from the same outside financial institution (e.g., an institution associated with finance server 116) to the server providing the construction planning platform discussed herein (e.g., construction planning server 104), regardless of which specific digital wallet is associated with the deposit request and is the final destination for funds deposited into the construction planning platform's digital wallet database. In other words, two different users of the construction planning platform may execute two separate deposit requests, with each request indicating that the funds should be deposited into the users' separate respective digital wallets, and system 100 may nonetheless use the same identification code to execute transfers of funds from finance server 116 to construction planning server 104 for both users' deposits. In some embodiments, only after the funds have been transferred to construction planning server 104 are the funds then allocated to a specific digital wallet in accordance with the internal database structure and logic of construction planning server 104 acting on database 106.

At block 308, the system updates the database, by the construction planning server, to reflect the deposit of funds into the first digital wallet. As discussed above, fund allocation in the construction planning platform provided by system 100 may be maintained in the digital wallet database in accordance with any suitable database structure, such that information stored in the database may be created, modified, augmented, and/or deleted by system 100 (e.g., by server 104) in order to represent deposits of funds into wallets or accounts, withdrawals of funds out of wallets or accounts, and/or movement of funds between wallets and/or accounts. Thus, in accordance with a deposit executed in response to the message sent at block 306 and the request made at block 304, server 104 may update one or more fields or items stored in the digital wallet database (e.g., in database 106) to reflect the deposit of funds into the first digital wallet.

In some embodiments, the database may be updated to reflect the deposit of funds automatically in response to one or more conditions being met, such as confirmation of the transfer of funds from finance server 116 being received; alternately or additionally, the database may be updated to reflect the deposit of funds at a predefined or user-defined time, such as at a scheduled time for a refresh of the amounts of funds in one or more digital wallets of the system.

At block 310, the system receives, at the construction planning server, from the first mobile electronic device operating the application interface for facilitating construction work, data comprising a withdrawal request for the first digital wallet associated with the mobile electronic device. In some embodiments, receipt of the data may share any one or more characteristics in common with the receipt of data discussed above with respect to block 304.

In some embodiments, the data received at block 310 from the first mobile electronic device may indicate an amount of funds to be withdrawn from the first digital wallet, an indication of the identity of the first digital wallet, an indication of one or more sources to which the funds should be transferred, and/or an indication of a time at which the withdrawal should be executed.

At block 312, the system transmits, from the construction planning server to the remote server associated with a plurality of identification codes for facilitating payments (e.g., the finance server), a second funds transfer message. In some embodiments, the finance server may be finance server 116 is system 100, and may receive the finds transfer message from server 104 via network communication over network 102.

In some embodiments, the transmission of the second funds transfer message may be executed by the system (e.g., by server 116) in response to the system receiving the withdrawal request from the user, as discussed above at block 310. In some embodiments, the second funds transfer message may be sent immediately upon receiving the withdrawal request, upon the satisfaction of one or more predefined conditions, and/or at a predefined or user-specified time.

At block 312a, the second funds transfer message comprises an indication of a second amount of funds to be withdrawn from the first digital wallet. In some embodiments, this second amount of funds is an amount that was indicated in the withdrawal request initiated by the user at the first mobile electronic device.

At block 312b, the second funds transfer message comprises a second identification code of the plurality of identification codes, wherein the second identification code is uniquely associated with transferring funds from the database of the system. In some embodiments, the second identification code may share any one or more characteristics in common with the first identification code discussed above with respect to block 306b, including being a code that is usable by a money transfer system or other financial system associated with the finance server to send or receive funds between the finance server and a specific other entity. That is, the second identification code may indicate the entity with which the finance server should exchange funds in accordance with the code, which in the case of block 312b is the construction planning server 104. Furthermore, the second identification code may indicate whether funds should be sent from the finance server to the other entity, or whether funds should be sent from the other entity to the finance server. In the case of block 312b and the corresponding deposit request of block 310, the identification code may indicate that funds should be transferred away from construction planning server 104 to finance server 116.

In some embodiments, the second identification code may be included in the second funds transfer message sent to the finance server without any need for a user of system 100 to manually enter or explicitly indicate the identification code. For example, the second identification code may be automatically called by an API of the platform provided by system 100, such that the second identification code is automatically appended to the second funds transfer message, or otherwise automatically called by the system, in response to a user executing an input indicating a withdrawal request. Thus, a user may simply indicate an amount of funds to be transferred to a financial service, and select a GUI object to execute the withdrawal; in response to detecting selection of this GUI object, the system may automatically call the second identification code as part of executing the withdrawal.

In some embodiments, the second identification code may be a “paybill” number used by a mobile phone-based money transfer systems, such as M-PESA.

At block 312c, the second identification code is usable for withdrawal requests for each of a plurality of digital wallets in the database. That is, in some embodiments, the same second identification code may be used to effect transfers of funds from the server providing the construction planning platform discussed herein (e.g., construction planning server 104) to the same outside financial institution (e.g., an institution associated with finance server 116), regardless of which specific digital wallet is associated with the withdrawal request and from which the funds in the construction planning platform's digital wallet database originate. In other words, two different users of the construction planning platform may execute two separate withdrawal requests, with each request indicating that the funds should be withdrawn from the users' separate respective digital wallets, and system 100 may nonetheless use the same identification code to execute transfers of funds from construction planning server 104 to finance server 116 for both users' withdrawals. In some embodiments, accounting for the specific digital wallet in the construction planning from which funds are taken is performed in accordance with the internal database structure and logic of construction planning server 104 acting on database 106.

At block 314, the system updates the database, by the construction planning server, to reflect the withdrawal of funds from the first digital wallet. As discussed above, fund allocation in the construction planning platform provided by system 100 may be maintained in the digital wallet database in accordance with any suitable database structure, such that information stored in the database may be created, modified, augmented, and/or deleted by system 100 (e.g., by server 104) in order to represent deposits of funds into wallets or accounts, withdrawals of funds out of wallets or accounts, and/or movement of funds between wallets and/or accounts. Thus, in accordance with a withdrawal executed in response to the message sent at block 312 and the request made at block 310, server 104 may update one or more fields or items stored in the digital wallet database (e.g., in database 106) to reflect the withdrawal of funds from the first digital wallet.

Thus, method 300 provides a method for harnessing systems, such as system 100, to execute deposits and/or withdrawals of funds into and out of a digital wallet of a platform for facilitating construction in the informal construction sector, in particular by using maintaining an internal database of digital wallets and using a pair of identification codes to execute deposits from and withdrawals to an external financial institution such as a mobile phone-based money transfer system, which are common in certain developing countries.

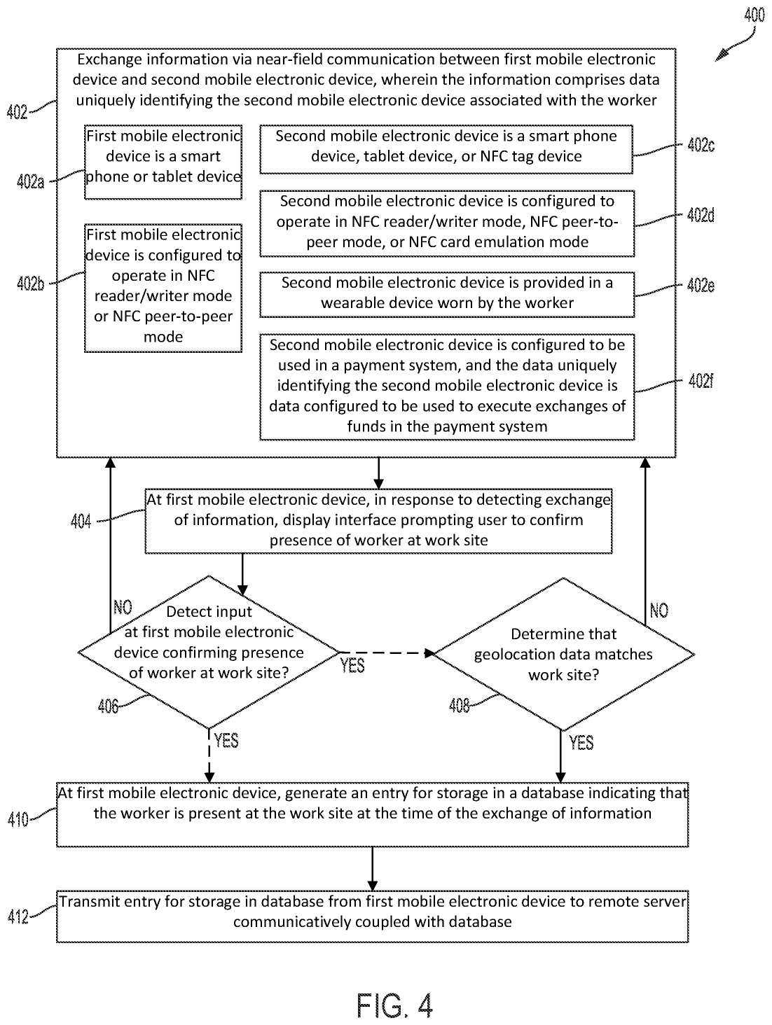

FIG. 4 illustrates a method 400 for verifying worker presence at a construction work site, in accordance with some embodiments. In some embodiments, method 300 may be performed by a computerized system for planning, execution, and verification of construction projects and tasks, such as system 100 as described above with respect to FIG. 1. In the context of this description, it is contemplated that system 100 provides a platform including desktop and mobile application graphical user interfaces accessible by users of system 100, and that the users of system 100 use the graphical user interfaces to access the system and cause the system to execute the method steps described herein.

Method 400 describes techniques for verifying and accounting for worker presence at a work site, which may be particularly useful in the informal, incremental, and small-scale construction sectors in developing countries, where informal workforces often do not have robust supervision of workers or a reliable way to account for hours worked by workers. This, as described herein, workers and/or work site supervisors using the mobile application platform provided by system 100 herein may use one or more mobile electronic devices to record worker presence at a work site using NFC to record a clock-in and clock-out times for workers registered in the platform.

While the discussion of method 400 refers to an exemplary mobile electronic device, it should be understood that the systems and techniques taught herein with respect to mobile electronic devices may be equally applicable, in some embodiments, when implemented via any suitable electronic device, such as a network-enabled desktop computer, laptop computer, tablet, or the like. This principle may be equally applicable to other instances in which method 400 refers to a mobile electronic device or to any electronic device, and to other instances in which any method, technique, or system disclosed herein refers to a mobile electronic device or to any electronic device. Furthermore, while method 400 refers to an exemplary technique for verifying worker presence using NFC communication devices, it should be understood that method 400 may, in some embodiments, us one or more alternate or additional methods for verifying worker presence, including using any alternative touchless electronic communication devices and/or including using any one or more biometric presence verification techniques (e.g., fingerprint scanning, retinal scanning, voice recognition, face recognition, etc.)

For example, a work site supervisor may use the mobile application to activate NFC functionality of his portable electronic device (e.g., smart phone) to communicate via NFC with a mobile device carried by a worker. In some embodiments as described below, a worker tracking system leveraging the platform provided by system 100 may be configured to be compatible with NFC devices configured to be used in payment systems that are common in developing countries, such that workers may be more likely to have an NFC-enabled payment device even if they do not own or carry a smart phone. Upon detecting the presence of the worker's device, the system may record a check-in time or check-out time of the worker, in some embodiments in further accordance with approval (e.g., tapping a button on the mobile interface to confirm) by the supervisor. Clock-in and clock-out times may be used to automatically, reliably, and transparently record hours worked by members of informal workforces, which may provide an accurate basis on which to pay workers for their hours worked (for example using the digital wallet system described above with respect to method 300 in FIG. 3) as well as a reliable way for informal workers to document their hours workers to establish their experience in attempting to secure future work.

At block 402, the system executes an exchange of information via near-field communication (NFC) between a first mobile electronic device and a second mobile electronic device, wherein the information comprises data uniquely identifying the second mobile electronic device associated. In some embodiments, one or more of the first and second electronic devices may be executing the mobile application platform provided by the systems described herein, and the exchange of information via NFC may be automatically triggered when the two mobile devices are brought within a communicative range of one another. In some embodiments, in order to trigger the exchange of information, one or both devices may require a user to execute a command (e.g., pressing or tapping a button on the device) to activate the NFC functionality of the device and to allow the exchange of information.

In some embodiments, the first mobile electronic device is a device carried by a work site supervisor, while the second mobile electronic device is a device carried by a worker. In some embodiments, the second mobile electronic device may be uniquely associated with the worker, such that the presence of the second device may be relied on to electronically demonstrate the presence of the worker with which it is associated. By exchanging information, the first device may receive information about the identity of the second device and/or about an identity of a construction worker associated with the second device. As explained herein, this information about the identity of the second device and/or of an associated worker may be used by the system to automatically log a clock-in time or a clock-out time for a worker at a work site, and to thereby automatically record hours and locations worked by the worker, which may be used for calculating worker compensation and/or for documenting worker experience.

In the example of system 100 in FIG. 1, the first mobile electronic device may be a mobile electronic device of supervisor 110, and the second mobile electronic device may be a mobile electronic device of worker 112. As shown in FIG. 1, the two devices may be configured to be capable of communicating with each other via NFC 114.

At block 402a, the first mobile electronic device is a smart phone or tablet device. In some embodiments, the first mobile electronic device may be a smart phone device, tablet device, or other mobile computing device that, in addition to being NFC-enabled, is also network-enabled for communication with other components of system 100 at range, such as via network 102. If a supervisor's mobile electronic device is fully network-enabled and can communicate with remote components of system 100, then workers who have only NFC-enabled but not fully network-enabled devices (as discussed further below) may still utilize the clock-in/clock-out features of the platform provided by system 100.

At block 402b, the first mobile electronic device is configured to operate in NFC reader/writer mode, NFC peer-to-peer mode, or NFC card emulation mode. By being configured to function in a plurality of different NFC modes, the first mobile electronic device may be able to communicate with a variety of different kinds of NFC-enabled worker devices, thereby making the worker-tracking system more adaptable to informal workforces where different workers may use different devices for clocking in and clocking out.

At block 402c, the second mobile electronic device is a smart phone device, tablet device, or NFC tag device. In some embodiments, the second mobile electronic device may be a smart phone device, tablet device, or other mobile computing device that, in addition to being NFC-enabled, is also network-enabled for communication with other components of system 100 at range, such as via network 102. However, in some alternative embodiments, the second mobile electronic device may be a simpler NFC device that is not fully network-enabled, such as an NFC tag device. An NFC tag device may be readable by another NFC-enabled device, such as a supervisor's NFC-enabled smart phone or tablet, but may be unable itself to communicate with components of system 100 at a distance via other electronic communication mediums, such as network 102. In some embodiments, NFC tag devices may be cheaper than fully network-enabled devices, and therefore may be able to be distributed to workers in an informal work force, at relatively low cost, for use in the worker tracking systems described herein. Thus, despite not being fully network-enabled, an NFC tag device may nonetheless be able to store information identifying the device and/or the worker and thereby allowing the system to detect and determine the worker's presence at a work site.

At block 402d, the second mobile electronic device is configured to operate in NFC reader/writer mode, NFC peer-to-peer mode, or NFC card emulation mode. In some embodiments, the different workers' mobile electronic devices may be configured to operate in different modes depending on the characteristics of the device (e.g., whether the device is a fully network-enabled device or a not).

At block 402e, the second mobile electronic device is provided in a wearable device work by a worker associated with the second mobile electronic device. In some embodiments, an NFC-enabled device carried by a worker may be provided in a wearable housing, such as a bracelet, lanyard, or the like. Providing an NFC-enabled device to be carried by a worker in a wearable housing may reduce risk that the device is lost or damaged during work. Furthermore, NFC-enabled wearable devices may be less expensive than smart phone or tablet devices, and may therefore be provided to workers by supervisors or contractors at a lower cost.

At block 402f, the second mobile electronic device is configured to be used in a payment system, and the data uniquely identifying the second mobile electronic device is data configured to be used to execute exchanges of funds in the payment system. In some embodiments, rather than using dedicated NFC-enabled devices for worker tracking or using general-purpose smart-devices such as smart phones or tablets, workers may instead participate in the worker tracking system provided by the platform described herein by using NFC-enabled payment devices to establish their presence at a work site.

In some embodiments, preexisting NFC-enabled payment devices may be configured to be readable by NFC-enabled systems, and to provide unique identifying information that identifies the device to a device that is reading it. For example, these NFC payment devices may provide an identification code, such as a payment account number, a routing number, a “paybill” code for use in money transfer systems such as M-PESA, or the like. While the identification code may normally be used by financial devices to initiate a financial transaction with an account associated with the identification code, the platform described herein may bootstrap onto the such payment devices by reading the code provided by such a device, storing data associating that code with an identity of a worker corresponding to the device, and thereafter using detection of that code to detect and electronically demonstrate the presence of that worker at a work site. In this way, even if a worker does not own a mobile phone or a dedicated NFC worker tracking device, the user may use a NFC payment device to participate in the worker tracking system disclosed herein, in a similar manner that a worker using a dedicated NFC worker tracking tag would.

Furthermore, in embodiments in which a worker uses an NFC payment device for clocking in and clocking out of a worksite, the platform disclosed herein may use the NFC payment system both to account for the time and place that a worker is present, and further to execute payment to the worker for hours worked and/or for tasks completed. For example, when checking out of a work site after working for a day using an NFC payment device, a supervisor's mobile electronic device may use NFC communication with the worker's NFC payment device to both (a) identify the worker and account for his presence at the time of clocking out and (b) to cause the system to execute a payment of funds to the worker for his hours worked, wherein the payment of funds is carried out using the native payment system of the NFC payment device. It should be noted that, in some embodiments, when workers are paid directly via an NFC payment device, the payment to the worker may be executed in the system in the same manner as a “withdrawal” from a supervisor's or contractor's wallet, rather than an intra-system payment between two wallets, because the worker's NFC payment device may be associated with an external financial institution to the construction planning platform discussed herein.

At block 404, in response to detecting the exchange of information, the system displays, at the first mobile electronic device, an interface prompting a user to confirm the presence of a worker at the work site. In some embodiments, the first mobile electronic device may be automatically caused to display an interface prompting a user to confirm the worker's presence upon detecting the exchange of information, while in some embodiments the first mobile electronic device may be prompted to display such an interface only after exchanging certain information with a remote server, such as server 104. In some embodiments, the first mobile electronic device may poll a remote server (e.g., server 104) to determine whether prompting for user confirmation is necessary. Determining whether prompting for user confirmation is required may be based on one or more criteria such as the worker's identity, the work site identity, a time of day, a geographic location, a worker's work history, etc.

In some embodiments, an interface prompting a user to confirm the presence of a worker at the work site may comprise information regarding device identity, work site identity, worker identity, date, and/or time. The interface may further comprise one or more user interface objects allowing a user to confirm the worker's presence for check-in or check-out, such as a “check-in” button that may be tapped by a user, a “check-out” button that may be tapped by a user, or a simple “confirm” button that may be tapped by a user. The interface may also include a user interface object to decline or reject confirmation, such as when a worker is not scheduled to work, or if a worker is attempting to check in to an incorrect work site or with an incorrect NFC device.

At block 406, the system determines whether an input is detected at the first mobile electronic device confirming the presence of a worker at the work site. In some embodiments, the input may be any suitable input such as a tap on a user interface object or a press of a button. In some embodiments, the determination as to whether such an input is detected may be made locally at the first mobile electronic device, while in some embodiments it may be made remotely from the first mobile electronic device, such as at server 104.

In accordance with determining that the system has not detected the input confirming the presence of the worker at the work site (e.g., the system detects an input rejecting the confirmation, or the prompt to confirm times out), method 400 may revert to an idle state and return to block 402 if another NFC exchange of information is detected. In accordance with determining that the system has detected the input confirming the presence of the worker at the work site, method 400 may proceed, in different embodiments, either to block 408 or directly to block 410 (circumventing block 408), as shown in FIG. 4.

At block 408, the system determines whether geolocation data associated with the exchange of information matches geolocation data of the work site. In some embodiments, the geolocation data associated with the exchange of information may be geolocation data captured by a sensor (e.g., a GPS sensor) of the first electronic device at a time of the exchange (or at a time associated with the exchange); in some embodiments, the geolocation data associated with the exchange of information may be geolocation data captured by a sensor (e.g., a GPS sensor) of the second electronic device at a time of the exchange (or at a time associated with the exchange). In some embodiments, the geolocation data associated with the exchange of information must be within a predefined threshold distance of the geolocation data associated with the worksite in order for a match to be determined.

In accordance with determining that the geolocation data does not match the work site, method 400 may revert to an idle state and return to block 402 if another NFC exchange of information is detected. In accordance with determining that the geolocation data does match the work site, method 400 may proceed to block 410.

In some embodiments, proceeding to block 410 may be contingent on one or more additional conditions being satisfied, such as time data associated with the NFC exchange (e.g., a time at which the exchange occurs) matching a worker's scheduled work hours within a predetermined threshold amount of time.

At block 410, the system generates an entry for storage in a database indicating that the worker is present at the work site at the time of the exchange of information. As noted above, proceeding to block 410 may be contingent upon the satisfaction of the conditions at blocks 406 and/or 408, and/or any additional predefined conditions. The entry generated for storage in a database may include information such as the worker's identity, a worksite identity, a worksite location, a time of clock-in or clock-out, an indication as to whether the worker is clocking in or clocking out, an indication as to the method by which the worker is clocking-in/clocking-out (e.g., the kind of NFC device being used by the worker), an identity of a supervisor with whom the worker is clocking in or clocking out, and or any other information relevant to verifying the worker's presence at the work site. The information may be generated in any suitable form for storage in a database, such as database 106 in system 100.

At block 412, the system transmits the entry for storage in the database from the first mobile electronic device to a remote server communicatively coupled with the database. In some embodiments, the entry is transmitted via a computer network such as network 102. In some embodiments, the transmission of the entry is performed automatically in response to the entry being generated; in some embodiments, the transmission of the entry is performed in response to an explicit command from a user, such as a command to upload a check-in entry or a command to sync a device with a remote database; in some embodiments, the transmission of the entry is performed at a predefined time for uploading one or more worker tracking entries to a remote database.

By uploading entries regarding worker presence verification to a network-connected database, the entries may be stored for future reference by one or more stakeholders/users of system 100, such that users may view comprehensive timetables for hours worked by one or more workers. As mentioned elsewhere herein, the data stored in the database may be used to establish worker hours for which payment should be made (e.g., via the digital wallet system provided by the platform disclosed herein) and/or to establish worker history to demonstrate and evaluate worker experience in making future hiring decisions for the worker.

The embodiments discussed above with respect to method 300 have contemplated that a mobile electronic device of a supervisor is the device that exchanges information with the remote server for worker-tracking purposes. However, in some embodiments in which the worker's device is a network-enabled device that can communicate with servers of the system directly (e.g., when the worker's device is a smart-phone or tablet), the worker's device may send clock-in/clock-out information directly to the server itself, upon the condition that the device is brought within NFC range of a supervisor's device, is brought within NFC range of another electronic device such as a smart timeclock, or is confirmed to be present at a worksite based on a location sensor (e.g., a GPS location sensor) integrated into the worker's device. This approach may, in some embodiments, be more efficient and simple than requiring supervisor approval and for information to be transmitted through a supervisor's device, though it relies on all workers having fully network-enabled devices rather than simple NFC-enabled wearables or NFC-enabled payment systems.

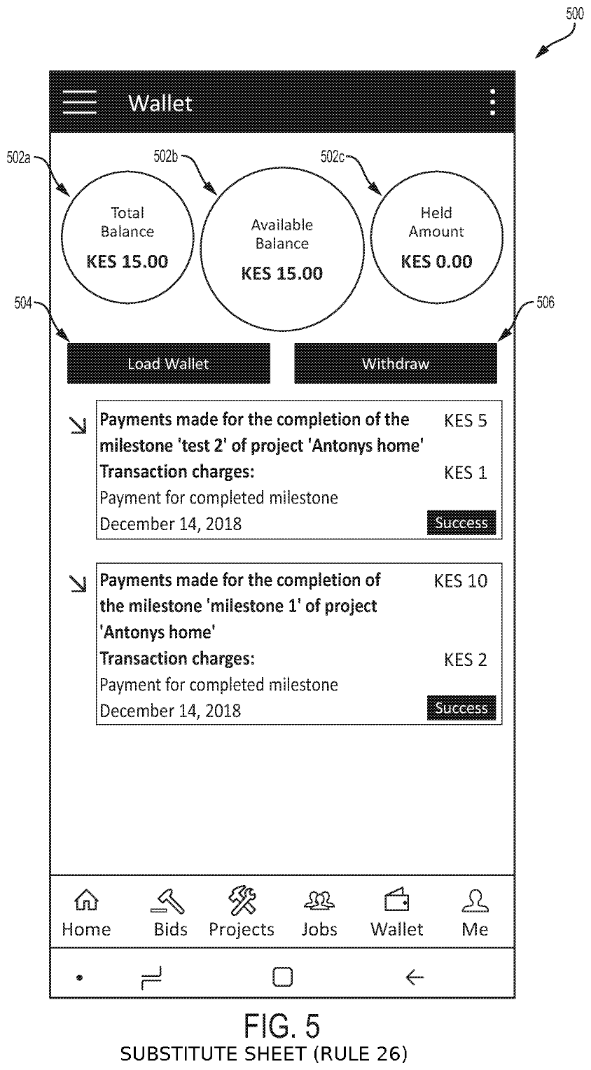

FIG. 5 illustrates a graphical user interface 500 for controlling a digital wallet in a platform for facilitating construction, in accordance with some embodiments. In some embodiments, interface 500 may be an interface of the platform for planning and executing construction projects, as provided by system 100 as described herein. In some embodiments, interface 500 is a touch-screen interface configured for use on a mobile electronic device, such as a smart phone or tablet. In particular, interface 500 is an interface for accessing a digital wallet provided in the platform, as discussed for example above with respect to method 300 in FIG. 3.

As discussed above, a digital wallet in the platform discussed herein may be used to pay for one or more construction tasks or projects, to pay construction workers for hours worked, and or to place funds in escrow pending the completion of a construction project or task. As further discussed above digital wallets in the platform may be funded via deposits from external financial services or institutions, and funds from digital wallets may be withdrawn from the platform and transferred to external financial services or institutions.

Interface 500 is a digital wallet interface displaying information about and controls for a digital wallet of a user of the platform. As shown in FIG. 5, interface 500 comprises balance indicators 502a-c, each of which indicates an amount of funds associated with the digital wallet of the user. Indicator 502a is a total balance indicator, and shows that the user's digital wallet contains a total balance of 15.00 Kenyan Shillings (KES). Indicator 502b is an available balance indicator, and shows that the user's available balance is also 15.00 KES, equal to the total balance, indicating that no funds in the wallet are allocated to escrow or otherwise held or obligated. Lastly, indicator 502c is a held amount indicator, showing the 0.00 KES of the user's funds are held in escrow or otherwise obligated to a project, party, or other user in the system.

Interface 500 further comprises load wallet icon 504 and withdraw icon 506. The icons 504 and 506 may each be selectable icons that may be tapped by a user in order to access functionality of the interface and system (e.g., including other interfaces) for loading (e.g., depositing) funds into the user's digital wallet and for withdrawing funds out of the user's digital wallet, respectively. When the user taps the one of icons 504 or 506, the system may cause the user's device to display one or more additional user interface objects or user interface screens to allow a user to enter or otherwise indicate any necessary information to allow the system to execute a deposit or withdrawal of funds to or from the user's digital wallet.

In some embodiments, tapping one of the icons 504 or 506 may one step in causing the system (e.g., system 100) to generate a deposit request or a withdrawal request, respectively, as discussed above with respect to blocks 304 and 310 in method 300 in FIG. 3.

Additionally, interface 500 may comprise a list showing recent transactions into and out of the wallet. The transactions list may indicate, for each transaction, an amount of funds for the transaction, a date and/or time for the transaction, a party to whom or from whom the funds were transferred, a milestone or task with which the transaction is associated, and/or a project with which the transaction is associated. In some embodiments, the platform disclosed herein may maintain a history of transactions made by a user of the platform, including deposits, withdrawals, and transfers within the platform. In some embodiments, a user's transaction history may be visible only to that individual user, while in some embodiments certain other users may have permissions to view that user's financial history (e.g., permissions to view one or more past transactions may be granted to family members, financial institutions, supervisors, etc.).

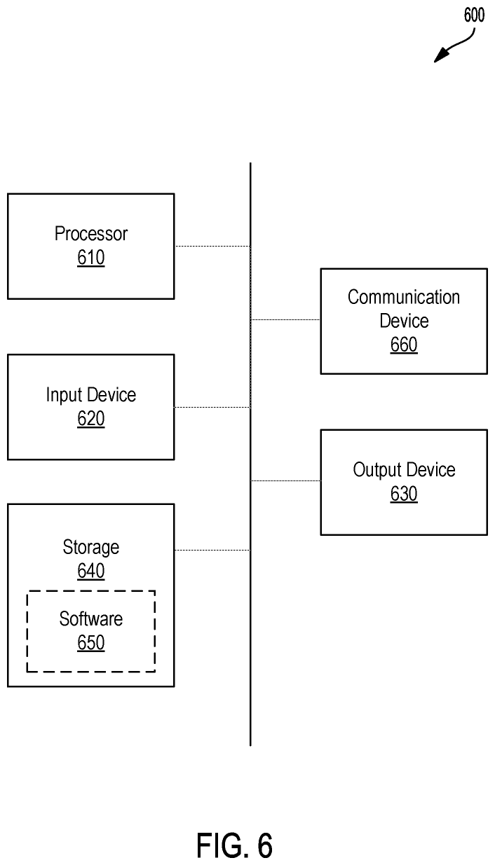

FIG. 6 illustrates an example of a computer, in accordance with some embodiments. Computer 600 can be a component of any of the systems or electronic devices described herein. For example, computer 600 can be a computing device included in system 100, server 104, server 116, any one or more of the mobile electronic devices discussed herein, and/or any other computerized electronic component discussed herein. In some embodiments, computer 600 may be configured to execute all or part of any of the methods described herein, such as all or part of methods 200, 300, and/or 400.

Computer 600 can be a host computer connected to a network. Computer 600 can be a client computer or a server. As shown in FIG. 6, computer 600 can be any suitable type of microprocessor-based device, such as a personal computer; workstation; server; or handheld computing device, such as a phone or tablet. The computer can include, for example, one or more of processor 610, input device 620, output device 630, storage 640, and communication device 660.

Input device 620 can be any suitable device that provides input, such as a touch screen or monitor, keyboard, mouse, or voice-recognition device. Output device 630 can be any suitable device that provides output, such as a touch screen, monitor, printer, disk drive, or speaker.

Storage 640 can be any suitable device that provides storage, such as an electrical, magnetic, or optical memory, including a RAM, cache, hard drive, CD-ROM drive, tape drive, or removable storage disk. Communication device 660 can include any suitable device capable of transmitting and receiving signals over a network, such as a network interface chip or card. The components of the computer can be connected in any suitable manner, such as via a physical bus or wirelessly. Storage 640 can be a non-transitory computer-readable storage medium comprising one or more programs, which, when executed by one or more processors, such as processor 610, cause the one or more processors to execute all or part of any of the methods or techniques described herein, such as all or part of methods 200, 300, and/or 400.

Software 650, which can be stored in storage 640 and executed by processor 610, can include, for example, the programming that embodies the functionality of the present disclosure (e.g., as embodied in the systems, computers, servers, and/or devices as described above). In some embodiments, software 650 can be implemented and executed on a combination of servers such as application servers and database servers.

Software 650 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 640, that can contain or store programming for use by or in connection with a system, apparatus, or device.

Software 650 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 600 can implement any operating system suitable for operating on the network. Software 650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

1. A system for verifying completion of a construction task, the system comprising one or more processors configured to be in network communication with a first mobile electronic device and a second mobile electronic device, wherein:
the first mobile electronic device is associated with a building party and comprises an image capture device;
the second mobile electronic device is associated with a verifying party; and
the one or more processors are configured to:
generate and store data representing a construction task to be completed by a user of the mobile electronic device, wherein the data comprises an indication that completion of the construction task must be verified by the verifying party;
receive, from the first mobile electronic device, a message indicating that the construction task has been completed, wherein the message comprises verification data;
transmit, to the second electronic device, a request to verify completion of the construction task, wherein the request comprises the verification data received from the first mobile electronic device;
receive, from the second mobile electronic device, a response message indicating whether or not completion of the construction task is verified;
if the response message indicates that completion of the construction task is verified, generate and store data indicating that the task is completed; and
if the response message indicates that completion of the construction task is not verified, generate and store data indicating that the task is not completed.

2. The system of claim 1, wherein the one or more processors are configured to:
if the response message indicates that completion of the construction task is verified, transmit a confirmation message to the first mobile electronic device confirming that the construction task has been verified; and
if the response message indicates that completion of the construction task is not verified, transmit a rejection message to the first mobile electronic device indicating that the construction task has not been verified.

3. The system of any one of claims 1-2, wherein the one or more processors are configured to:
if the response message indicates that completion of the construction task is verified, generate and store an indication in a database permitting pre-allocated funds associated with the construction task to be released from escrow.

4. The system of any one of claims 1-3, wherein the verification data comprises an image captured using the image capture device of the first mobile electronic device.

5. The system of claim 4, wherein the verification data comprises metadata associated with the image.

6. The system of claim 5, wherein the metadata comprises temporal data.

7. The system of any one of claims 5-6, wherein the metadata comprises location data.

8. A method for verifying completion of a construction task, the method performed at a system comprising one or more processors configured to be in network communication with a first mobile electronic device and a second mobile electronic device, wherein:
the first mobile electronic device is associated with a building party and comprises an image capture device; and
the second mobile electronic device is associated with a verifying party; and
the method comprising:
generating and storing, by the one or more processors, data representing a construction task to be completed by a user of the mobile electronic device, wherein the data comprises an indication that completion of the construction task must be verified by the verifying party;
receiving, by the one or more processors, from the first mobile electronic device, a message indicating that the construction task has been completed, wherein the message comprises verification data;
transmitting, from the one or more processors, to the second electronic device, a request to verify completion of the construction task, wherein the request comprises the verification data received from the first mobile electronic device;
receiving, by the one or more processors, from the second mobile electronic device, a response message indicating whether or not completion of the construction task is verified;
if the response message indicates that completion of the construction task is verified, generating and storing, by the one or more processors, data indicating that the task is completed; and
if the response message indicates that completion of the construction task is not verified, generating and storing, by the one or more processors, data indicating that the task is not completed.

9. A non-transitory computer-readable storage medium for verifying completion of a construction task, the non-transitory computer-readable storage medium storing instructions configured to be executed by a system comprising one or more processors configured to be in network communication with a first mobile electronic device and a second mobile electronic device, wherein:
the first mobile electronic device is associated with a building party and comprises an image capture device;
the second mobile electronic device is associated with a verifying party; and
execution of the instructions by the one or more processors causes the one or more processors to:
generate and store data representing a construction task to be completed by a user of the mobile electronic device, wherein the data comprises an indication that completion of the construction task must be verified by the verifying party;
receive, from the first mobile electronic device, a message indicating that the construction task has been completed, wherein the message comprises verification data;
transmit, to the second electronic device, a request to verify completion of the construction task, wherein the request comprises the verification data received from the first mobile electronic device;
receive, from the second mobile electronic device, a response message indicating whether or not completion of the construction task is verified;
if the response message indicates that completion of the construction task is verified, generate and store data indicating that the task is completed; and
if the response message indicates that completion of the construction task is not verified, generate and store data indicating that the task is not completed.

10. A system for facilitating payment using a digital wallet, the system comprising one or more processors configured to be in network communication with a mobile electronic device and with a remote server associated with a plurality of identification codes for facilitating payments, wherein the one or more processors are configured to:
receive, from the mobile electronic device, a deposit request indicating a request to deposit a first amount of funds into a digital wallet associated with a user account;
in response to receiving the deposit request, transmit, from the one or more processors to the remote server, a first funds transfer message comprising an indication of the first amount of funds and a first identification code of the plurality of identification codes, the first identification code uniquely associated with transferring funds to a digital wallet database of the system;
receive, from the mobile electronic device, a withdrawal request indicating a request to withdraw a second amount of funds from the digital wallet associated with the user account;
in response to receiving the withdrawal request, transmit, from the one or more processors to the remote server, a second funds transfer message comprising an indication of the second amount of funds and a second identification code of the plurality of identification codes, the second identification code uniquely associated with transferring funds from a digital wallet database of the system.

11. The system of claim 10, wherein the one or more processors are configured to generate and store the digital wallet database, the database representing a plurality of account-specific digital wallets, wherein the plurality of account-specific digital wallets comprises the digital wallet associated with the user account, and wherein the database stores a plurality of entries representing respective amounts of funds stored in each of the plurality of digital wallets.

12. The system of claim 11, wherein the one or more processors are configured to process deposit requests for each of the plurality of digital wallets using the same first identification code.

13. The system of any one of claims 11-12, wherein the one or more processors are configured to process withdrawal requests for each of the plurality of digital wallets using the same second identification code.

14. The system of any one of claims 11-13, wherein the one or more processors are configured to, after receiving a first funds transfer associated with the deposit request, update the database to reflect deposit of the first amount of funds to the digital wallet associated with the user account.

15. The system of any one of claims 11-14, wherein the one or more processors are configured to, after receiving a second funds transfer associated with the withdrawal request, update the database to reflect withdrawal of the second amount of funds from the digital wallet associated with the user account.

16. The system of any one of claims 10-15, wherein the mobile electronic device is configured to:
display a user interface comprising a first field for entry of a deposit amount;
receive, via an input device, a first input from a user entering the first amount as the deposit amount in the first field;
in response to receiving the first input, generate and transmit the deposit request.

17. The system of claim 16, wherein generating and transmitting the deposit request is executed without receiving the first identification code from the user.

18. The system of any one of claims 16-17, wherein the user interface comprises a second field for entry of a withdrawal amount, and wherein the mobile electronic device is configured to:
receive, via the input device, a second input from the user entering the second amount as the withdrawal amount in the second field;
in response to receiving the second input, generate and transmit the withdrawal request.

19. The system of claim 18, wherein generating and transmitting the withdrawal request is executed without receiving the second identification code from the user.

20. A method for facilitating payment using a digital wallet, the method performed at a system comprising one or more processors configured to be in network communication with a mobile electronic device and with a remote server associated with a plurality of identification codes for facilitating payments, the method comprising:
receiving, by the one or more processors, from the mobile electronic device, a deposit request indicating a request to deposit a first amount of funds into a digital wallet associated with a user account;
in response to receiving the deposit request, transmitting, from the one or more processors, to the remote server, a first funds transfer message comprising an indication of the first amount of funds and a first identification code of the plurality of identification codes, the first identification code uniquely associated with transferring funds to a digital wallet database of the system;
receiving, by the one or more processors, from the mobile electronic device, a withdrawal request indicating a request to withdraw a second amount of funds from the digital wallet associated with the user account;
in response to receiving the withdrawal request, transmitting, from the one or more processors, to the remote server, a second funds transfer message comprising an indication of the second amount of funds and a second identification code of the plurality of identification codes, the second identification code uniquely associated with transferring funds from a digital wallet database of the system.

21. A non-transitory computer-readable storage medium for facilitating payment using a digital wallet, the non-transitory computer-readable storage medium storing instructions configured to be executed by a system comprising one or more processors configured to be in network communication with a mobile electronic device and with a remote server associated with a plurality of identification codes for facilitating payments, wherein execution of the instructions by the one or more processors causes the one or more processors to:
receive, from the mobile electronic device, a deposit request indicating a request to deposit a first amount of funds into a digital wallet associated with a user account;
in response to receiving the deposit request, transmit, from the one or more processors to the remote server, a first funds transfer message comprising an indication of the first amount of funds and a first identification code of the plurality of identification codes, the first identification code uniquely associated with transferring funds to a digital wallet database of the system;
receive, from the mobile electronic device, a withdrawal request indicating a request to withdraw a second amount of funds from the digital wallet associated with the user account;
in response to receiving the withdrawal request, transmit, from the one or more processors to the remote server, a second funds transfer message comprising an indication of the second amount of funds and a second identification code of the plurality of identification codes, the second identification code uniquely associated with transferring funds from a digital wallet database of the system.

22. A system for verifying presence of a worker at a work site, the system comprising:
a first mobile electronic device associated with the work site, wherein the first mobile electronic device comprises a display, an input device, and a first near-field communication device; and
a second mobile electronic device associated with the worker, wherein the second mobile electronic device is comprises a second near-field communication device;
wherein the first and second mobile electronic devices are configured to exchange information via near-field communication with one another,
wherein the information comprises data uniquely identifying the second mobile electronic device associated with the worker; and
wherein the first mobile electronic device is configured to:
in response to detecting the exchange of information, display an interface prompting a user of the first mobile electronic device to confirm the presence of the worker at the work site;
detect, via the input device, a first input confirming the presence of the worker at the work site; and
in response to detecting the first input, generating an entry for storage in a database indicating that the worker is present at the work site at a time of the exchange of information.

23. The system of claim 22, wherein generating and storing the entry in the database is performed in accordance with determining that geolocation data associated with the time of the exchange matches geolocation data for the work site.

24. The system of claim 23, wherein the geolocation data is detected by a GPS sensor of the first mobile electronic device at a time associated with the time of the exchange.

25. The system of any one of claims 23-24, wherein the geolocation data is detected by a GPS sensor of the second mobile electronic device at a time associated with the time of the exchange.

26. The system of any one of claims 22-25, wherein the system comprises a remote server configured to receive, via network communication from the first mobile electronic device, a transmission comprising an instruction to store the entry in the database.

27. The system of any one of claims 22-26, wherein the first mobile electronic device is configured to function in a mode selected from: NFC reader/writer mode and NFC peer-to-peer mode.

28. The system of any one of claims 22-27, wherein the first mobile electronic device is one of a smart phone and a tablet.

29. The system of any one of claims 22-28, wherein the second mobile electronic device is configured to function in a mode selected from: NFC reader/writer mode, NFC peer-to-peer mode, and NFC card emulation mode.

30. The system of any one of claims 22-29, wherein the second mobile electronic device is one of a smart phone, a tablet, and an NFC tag.

31. The system of any one of claims 22-30, wherein the second mobile electronic device is an NFC tag embedded in a wearable device.

32. The system of any one of claims 22-31, wherein the second mobile electronic device is configured to be used in a payment system, and wherein the data uniquely identifying the second mobile electronic device is data configured to be used to execute exchanges of funds in the payment system.

33. The system of claim 32, wherein, in response to detecting the first input, the system executes a payment, via the payment system, to the second mobile electronic device.

34. The system of claim 33, wherein an amount of funds for the payment is determined in accordance with the time of the exchange of information.

35. A method for verifying presence of a worker at a work site, the method performed at a system comprising:
a first mobile electronic device associated with the work site, wherein the first mobile electronic device comprises a display, an input device, and a first near-field communication device; and
a second mobile electronic device associated with the worker, wherein the second mobile electronic device is comprises a second near-field communication device;
wherein the first and second mobile electronic devices are configured to exchange information via near-field communication with one another,
wherein the information comprises data uniquely identifying the second mobile electronic device associated with the worker; and
wherein the method comprises:
in response to detecting the exchange of information, displaying, by the first mobile electronic device, an interface prompting a user of the first mobile electronic device to confirm the presence of the worker at the work site;
detecting, via the input device, a first input confirming the presence of the worker at the work site; and
in response to detecting the first input, generating, by the first mobile electronic device, an entry for storage in a database indicating that the worker is present at the work site at a time of the exchange of information.

36. A non-transitory computer readable storage medium for verifying presence of a worker at a work site, the non-transitory computer-readable storage medium storing instructions configured to be executed by a system comprising:
a first mobile electronic device associated with the work site, wherein the first mobile electronic device comprises a display, an input device, and a first near-field communication device; and
a second mobile electronic device associated with the worker, wherein the second mobile electronic device is comprises a second near-field communication device;
wherein the first and second mobile electronic devices are configured to exchange information via near-field communication with one another,
wherein the information comprises data uniquely identifying the second mobile electronic device associated with the worker; and
wherein execution of the instructions by one or more processors of the first mobile electronic device causes the first mobile electronic device to:
in response to detecting the exchange of information, display an interface prompting a user of the first mobile electronic device to confirm the presence of the worker at the work site;
detect, via the input device, a first input confirming the presence of the worker at the work site; and
in response to detecting the first input, generating an entry for storage in a database indicating that the worker is present at the work site at a time of the exchange of information.
